(19) United States
(12) Patent Application Publication
(10) Pub. No.: US 2015/0301806 A1
(43) Pub. Date: Oct. 22, 2015

(54) TENTATIVE PROGRAM CODE IN AN EDITOR

(71) Applicant: The MathWorks, Inc., Natick, MA (US)

(72) Inventors: Adam C. Leon, Brookline, MA (US); Joseph R. Bienkowski, Ashland, MA (US); Bryan T. White, Holliston, MA (US); Joseph F. Hicklin, Upton, MA (US)

(73) Assignee: The MathWorks, Inc., Natick, MA (US)

(21) Appl. No.: 14/254,596

(22) Filed: Apr. 16, 2014

(51) Int. Cl. G06F 9/44

(52) U.S. Cl. CPC G06F 8/33

(57) ABSTRACT

A device may receive an indication that a portion of primary program code is to be displayed in a tentative code editor. The device may determine helper program code associated with the portion of primary program code. The device may provide a tentative code editor user interface that includes an editor portion, a helper portion, and an evaluation portion. The editor portion may be associated with manipulating the portion of primary program code. The helper portion may display the helper program code. The evaluation portion may display a result associated with the portion of primary program code. The device may receive input associated with manipulating the portion of primary program code to create tentative program code. The device may evaluate the tentative program code and provide a result associated with evaluating the tentative program code. The device may receive an indication to export, discard, or bookmark the tentative program code.

### BRIEF DESCRIPTION OF THE DRAWINGS

FIGS. 1A-1C are diagrams of an overview of an example implementation described herein;

FIG. 2 is a diagram of an example environment in which systems and/or methods described herein may be implemented;

FIG. 3 is a diagram of example components of one or more devices of FIG. 2;

FIGS. 4A-4E are diagrams of an example implementation relating to the example process shown in FIG. 7;

FIG. 5A-5C are diagrams of an additional example implementation relating to the example process shown in FIG. 7;

FIG. 6A-6C are diagrams of another example implementation relating to the example process shown in FIG. 7;

FIG. 7 is a flow chart of an example process for receiving tentative code via a tentative editor and receiving information associated with exporting, discarding, or bookmarking the tentative code;

FIGS. 8A-8J are diagrams of an example implementation relating to the example process shown in FIGS. 9A and 9B; and

FIGS. 9A and 9B are flow charts of an example process for receiving tentative figure code associated, with an iteration of a figure, and displaying the iteration of the figure in the tentative code editor.

### DETAILED DESCRIPTION

A technical computing environment (TCE) may allow a user to provide, via a user device, primary program code (primary code) associated with one or more tasks, such as simulating a behavior of a system (e.g., a static system, a dynamic system, etc.), performing one or more computations, (e.g., evaluating a function, plotting a function, plotting data, implementing an algorithm, etc.), etc. In some cases, the user may provide tentative program code (tentative code) (e.g., experimental program code, test program code, non-final program code) that the user may or may not wish to include in the primary code. For example, the user may provide tentative code associated with program diagnostics (e.g., code used to determine the state of the system at a given line of code, etc.) that the user does not wish to include in the primary code. The TCE may only be capable of providing (e.g., to the user) feedback associated with the tentative code (e.g., runtime feedback, feedback indicating whether the user has provided correct function names, correct function spelling, correct method names, etc.) by enabling a runtime environment and evaluating the primary code that includes the tentative code. However, enabling the runtime environment to provide feedback associated with the tentative code may lead to complications associated with management of an order of code execution of the primary code and/or the tentative code, management of an input argument associated with the primary code and/or the tentative code, management of modifying the tentative code, etc. Implementations described herein may allow a user to provide tentative code to a tentative code editor (tentative editor) that may evaluate the tentative code and provide a result, associated with the tentative code, to the user. In this way, the user may experiment with, test, modify, revise, etc. the tentative code before including the tentative code in primary code.

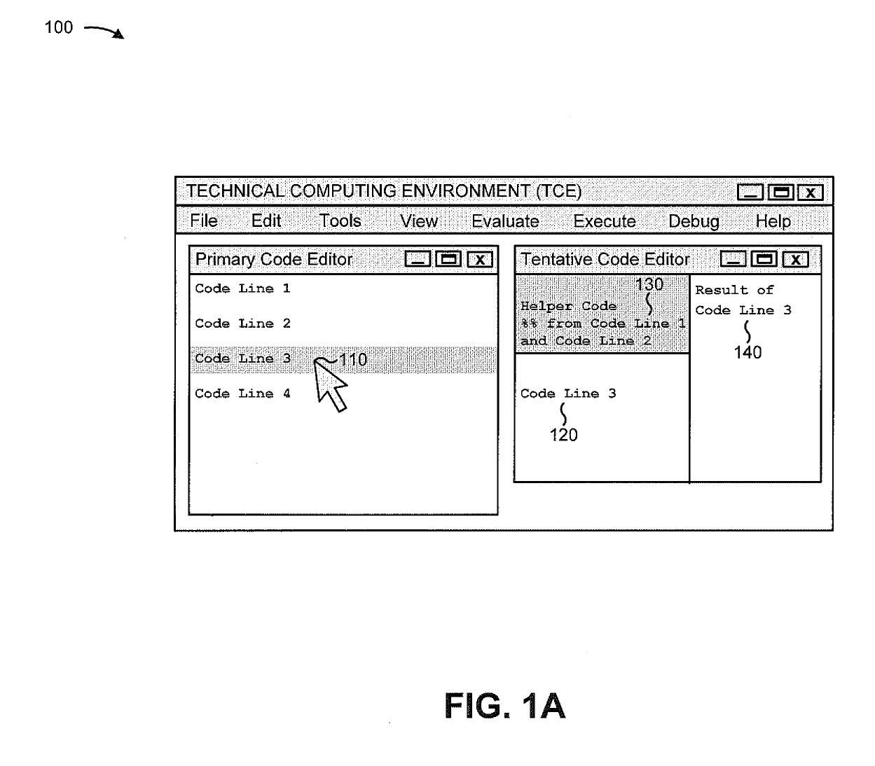

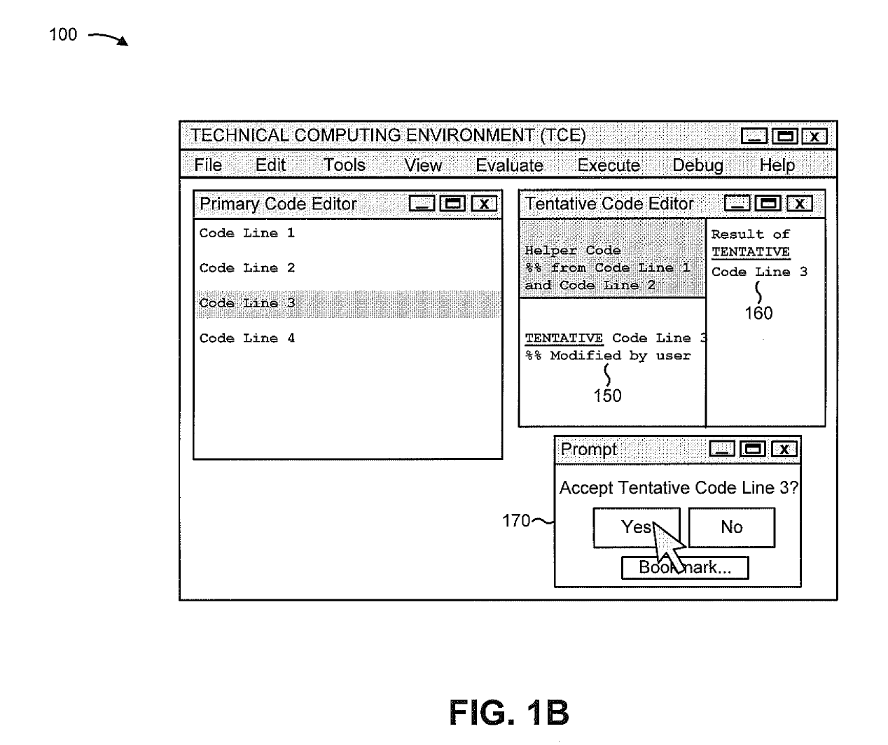

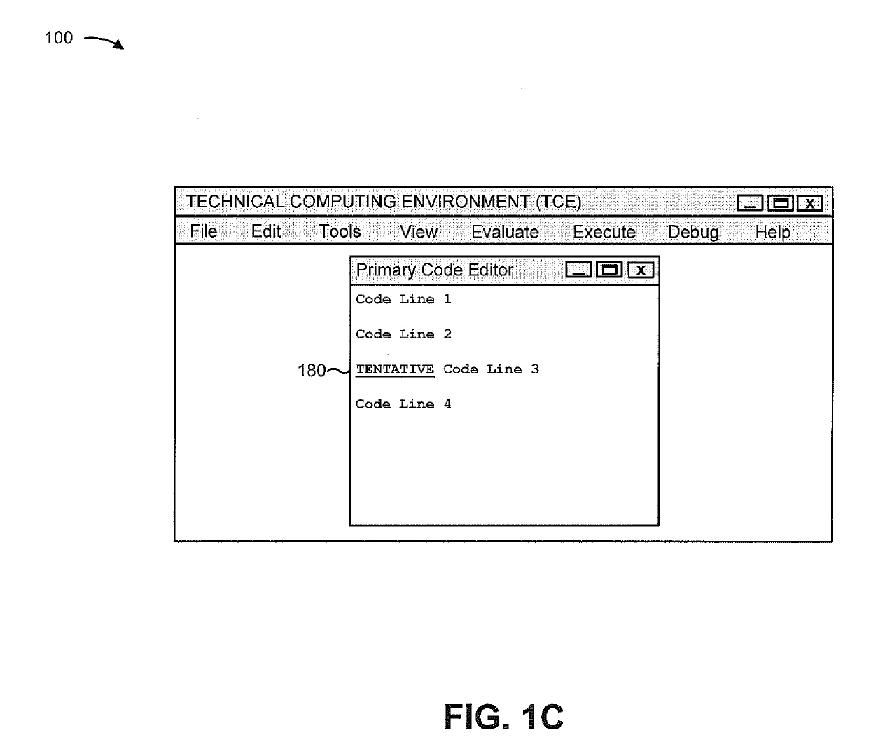

FIGS. 1A-1C are diagrams of an overview of an example implementation 100 described herein. For the purposes of example implementation 100, assume that a user has provided primary code (e.g., code lines 1 through 4) via a primary code editor (primary editor) window associated with a TCE. In some implementations, the primary code editor may include a programming environment where results of evaluating and/or executing primary code are provided based on a command provided by the user. Additionally, or alternatively, the primary code editor may include a live editor. A live editor may refer to a programming environment where results of evaluating and/or executing primary code are provided for display while a user is editing and/or providing the primary code. Further, assume that the user wishes to modify code line 3 (e.g., to create tentative code line 3), but that the user wishes to see a result associated with tentative code line 3 before including tentative code line 3 in the primary code. Finally, assume that TCE is capable of providing a tentative editor that allows the user to provide tentative code line 3 and view a result associated with tentative code line 3.

As shown in FIG. 1A, and by reference number 110, the user may indicate (e.g., by double clicking) that the user wishes to copy code line 3 to the tentative editor. As shown, the TCE may display a tentative editor window based on the user selecting code line 3. As shown by reference number 120, the tentative editor window may include an editor portion that displays code line 3 and allows the user to modify code line 3 to create tentative code line 3. As shown by reference number 130, the tentative editor window may also include a helper code portion that displays helper program code (helper code) associated with code line 3 (e.g., program code that may be used to evaluate code line 3 and/or tentative code line 3 within the tentative editor). As shown by reference number 140, the tentative editor window may also include an evaluation portion that is to display a result of evaluating code line 3 and/or tentative code line 3 (e.g., based on the helper code). In some implementations, the editor portion, the helper portion, and the evaluation portion may be included in a single window. Additionally, or alternatively, the editor portion, the helper portion, and the evaluation portion may be included in separate windows. Additionally, or alternatively, the evaluation portion, the helper portion, and/or the editor portion, respectively, may be included in multiple windows. As shown, the evaluation portion of the tentative editor window may display a result associated with code line 3 when the TCE initially provides the tentative editor window.

As shown in FIG. 1B, and by reference number 150, the user may modify code line 3 by providing input to the editor portion of the tentative editor window. As shown, the user may modify code line 3 to create tentative code line 3. As shown by reference number 160, the TCE may receive an indication to evaluate tentative code line 3, the TCE may evaluate tentative code line 3 (e.g., based on the helper code), and the TCE may update the evaluation portion of the tentative editor window to display a result associated with evaluating tentative code line 3. For example, the TCE may receive the indication to evaluate based on user input, based on a real-time evaluation setting associated with the tentative editor window, etc. As shown by reference number 170, the user may indicate (e.g., by selecting a “Yes” button included in a prompt window) that the user wishes to accept tentative code line 3.

As shown in FIG. 1C, and by reference number 180, the TCE may export tentative code line 3 into the primary editor window based on the user indicating that the user wishes to accept tentative code line 3. As shown, the TCE may replace code line 3 with tentative code line 3 within the primary editor window. In this way, a user may provide tentative code to a tentative editor that may evaluate the tentative code and provide feedback to the user. As such, the tentative editor may allow the user to experiment, test, modify, revise, etc. the tentative code before including the tentative code in primary code.

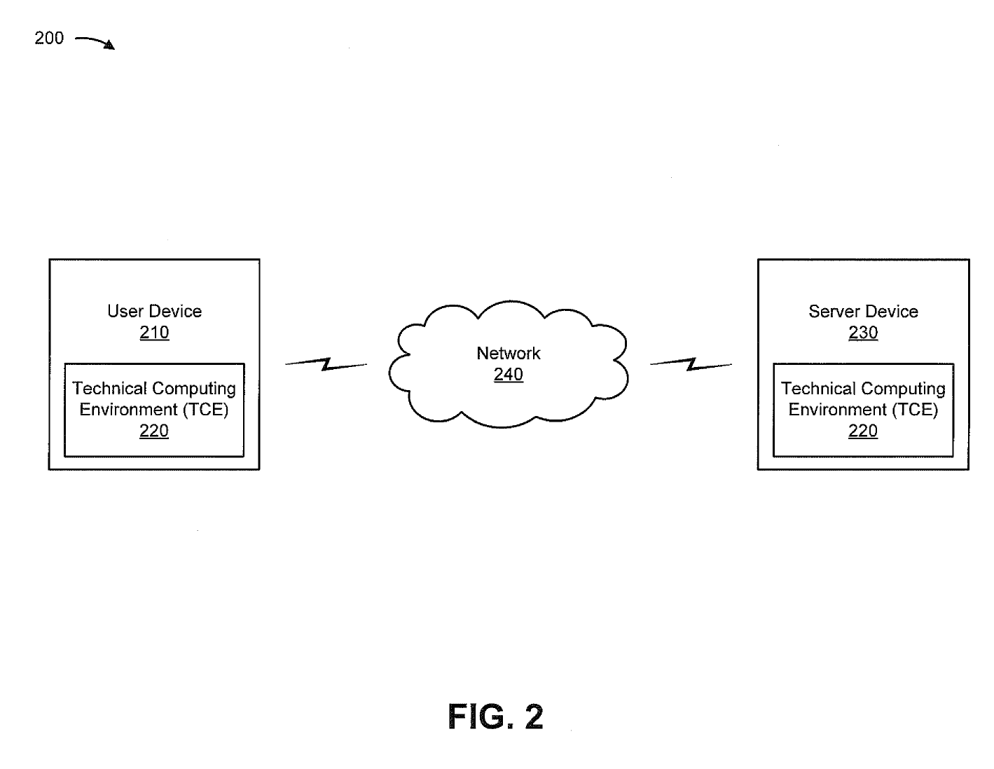

FIG. 2 is a diagram of an example environment 200 in which systems and/or methods described herein may be implemented. As shown in FIG. 2, environment 200 may include a user device 210, which may include a technical computing environment (TCE) 220. Furthermore, environment 200 may include a server device 230, which may include TCE 220, and a network 240. Devices of environment 200 may interconnect via wired connections, wireless connections, or a combination of wired and wireless connections.

User device 210 may include one or more devices capable of receiving, generating, storing, evaluating, and/or providing program code and/or information associated with program code, such as primary code or tentative code provided to user device 210. For example, user device 210 may include a computing device, such as a desktop computer, a laptop computer, a tablet computer, a handheld computer, a server, a mobile phone (e.g., a smart phone, a radiotelephone, etc.), or a similar device. User device 210 may evaluate program code (e.g., primary code and/or tentative code) by, for example, executing the program code. In some implementations, user device 210 may receive information from and/or transmit information to server device 230 (e.g., primary code, tentative code, and/or information associated with primary code and/or tentative code).

User device 210 may host TCE 220. TCE 220 may include any hardware-based component or a combination of hardware and software-based components that provides a computing environment that allows tasks to be performed (e.g., by users) related to disciplines, such as, but not limited to, mathematics, science, engineering, medicine, and business. TCE 220 may include a text-based environment (e.g., MATLAB® software), a graphically-based environment (e.g., Simulink® software, Stateflow® software, SimEvents® software, etc., by The MathWorks, Inc.; VisSim by Visual Solutions; LabView® by National Instruments; Agilent VEE by Agilent Technologies; Advanced Design System (ADS) by Agilent Technologies; Agilent Ptolemy by Agilent Technologies; etc.), or another type of environment, such as a hybrid environment that may include, for example, a text-based environment and a graphically-based environment.

TCE 220 may include, for example, a user interface that provides an editor portion (e.g., a primary editor portion, a tentative editor portion, etc.) that permits a user to input program code (e.g., textual program code, graphical program code, a combination of textual program code and graphical program code, etc.). In some implementations, TCE 220 may provide multiple user interfaces associated with the program code (e.g., a primary editor user interface, a tentative editor user interface, etc.). Additionally, or alternatively, TCE 220 may include a user interface that provides an evaluation portion that provides a result (e.g., a result associated with primary code, a result associated with tentative code, etc.) corresponding to program code displayed in the editor portion. Additionally, or alternatively, TCE 220 may allow program code associated with a first user interface (e.g., a primary editor user interface) to be imported to and/or exported from a second user interface (e.g., a tentative editor user interface).

Server device 230 may include one or more devices capable of receiving, generating, storing, evaluating, and/or providing program code and/or information associated with program code, such as primary code and/or tentative code. For example, server device 230 may include a computing device, such as a server, a desktop computer, a laptop computer, a tablet computer, a handheld computer, a mobile device, or a similar device. In some implementations, server device 230 may include an embedded device, such as a microcontroller (e.g., an Arduino microcontroller, a device utilizing an ARM architecture, a device utilizing an x86 architecture, etc.). In some implementations, server device 230 may host TCE 220. In some implementations, user device 210 may be used to access one or more TCEs 220 running on one or more server devices 230. For example, multiple server devices 230 may be used to evaluate program code (e.g., serially or in parallel) and may provide respective results of evaluating the program code to user device 210.

In some implementations, user device 210 and server device 230 may be owned by different entities. For example, an end user may own user device 210, and a third party may own server device 230. In some implementations, server device 230 may include a device operating in a cloud computing environment. In this way, front-end applications (e.g., a user interface) may be separated from back-end applications (e.g., program code execution).

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), a cellular network, an ad hoc network, an intranet, the Internet, a fiber optic-based network, a satellite network, a cloud computing network, and/or a combination of these or other types of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

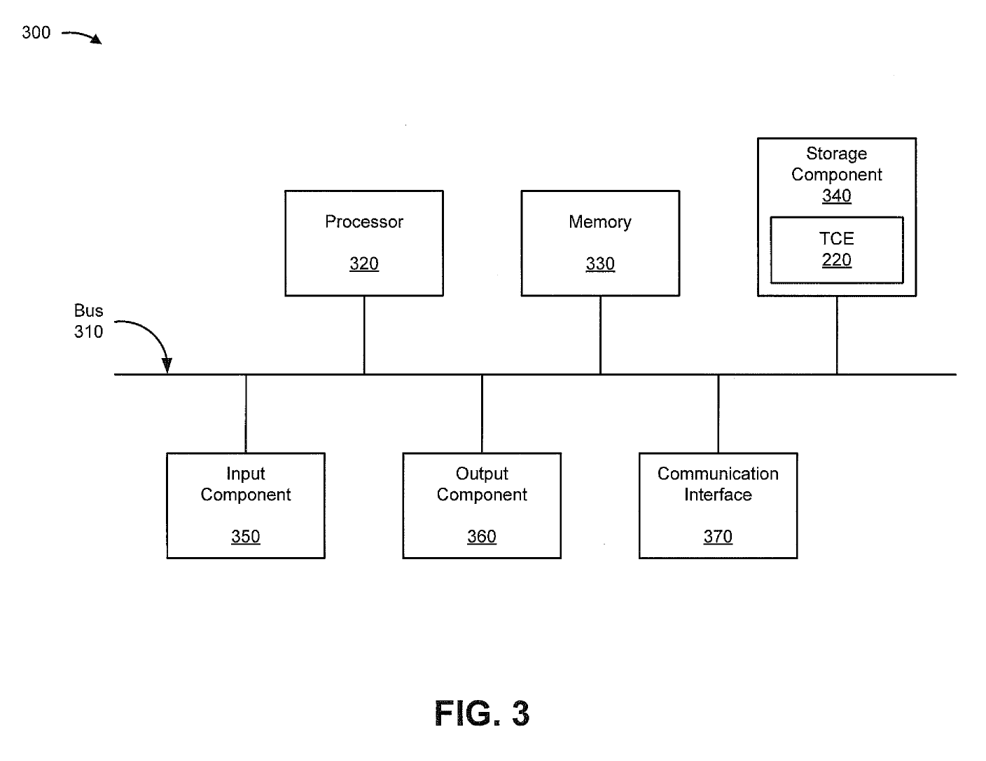

FIG. 3 is a diagram of example components of a device 300, which may correspond to user device 210 and/or server device 230. In some implementations, each of user device 210 and/or server device 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a path that permits communication among the components of device 300. Processor 320 may include a processor (e.g., a central processing unit, a graphics processing unit, an accelerated processing unit, etc.), a microprocessor, and/or any processing logic (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash, magnetic, or optical memory) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive. In some implementations, storage component 340 may store TCE 220.

Input component 350 may include a component that permits a user to input information to device 300 (e.g., a touch screen display, a keyboard, a keypad, a mouse, a button, a switch, etc.). Output component 360 may include a component that outputs information from device 300 (e.g., a display, a speaker, one or more light-emitting diodes (LEDs), etc.).

Communication interface 370 may include a transceiver-like component, such as a transceiver and/or a separate receiver and transmitter, that enables device 300 to communicate with other devices, such as via a wired connection, a wireless connection, or a combination of wired and wireless connections. For example, communication interface 370 may include an Ethernet interface, an optical interface, a coaxial interface, an infrared interface, a radio frequency (RF) interface, a universal serial bus (USB) interface, or the like.

Device 300 may perform various operations described herein. Device 300 may perform these operations in response to processor 320 executing software instructions included in a computer-readable medium, such as memory 330 and/or storage component 340. A computer-readable medium is defined as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

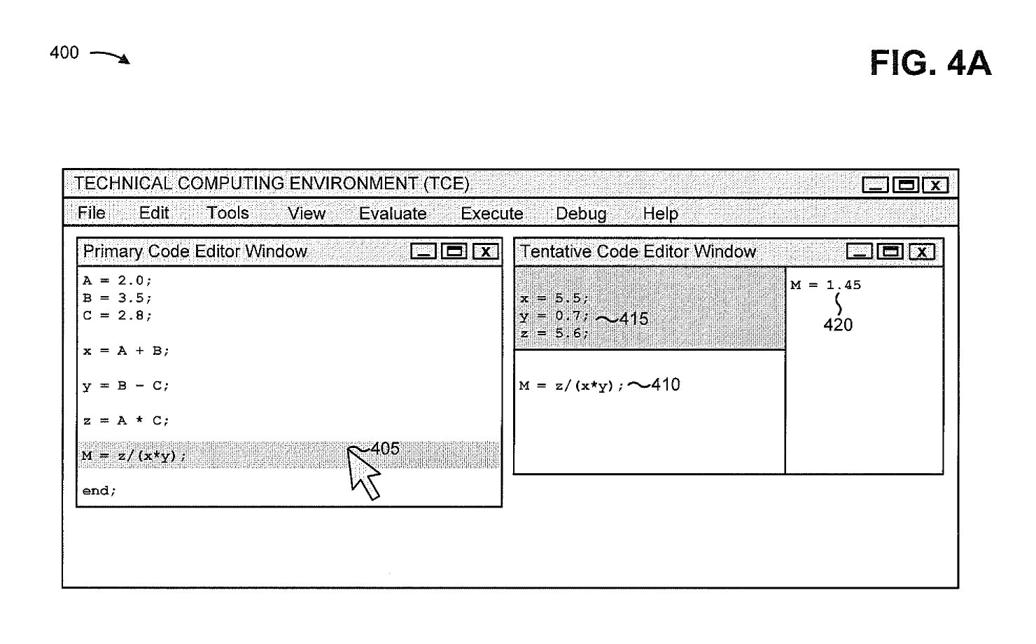

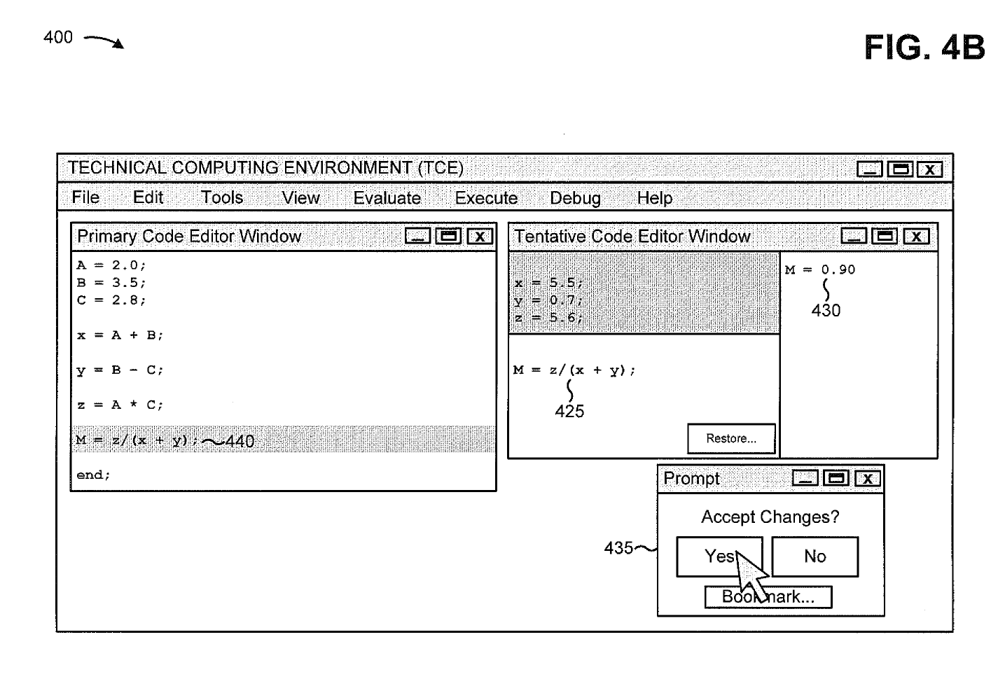

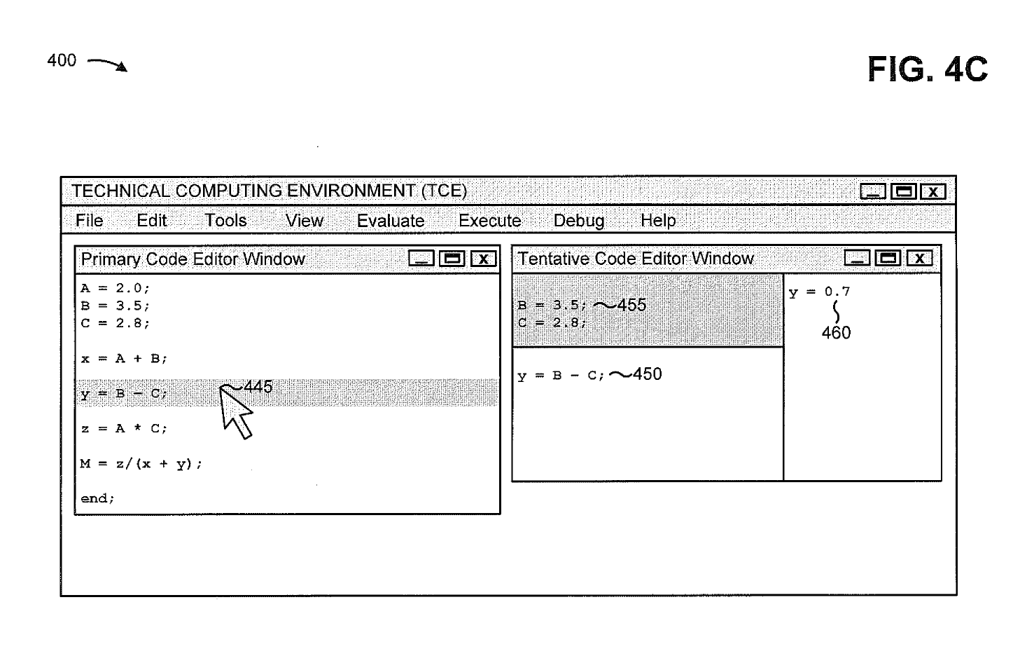

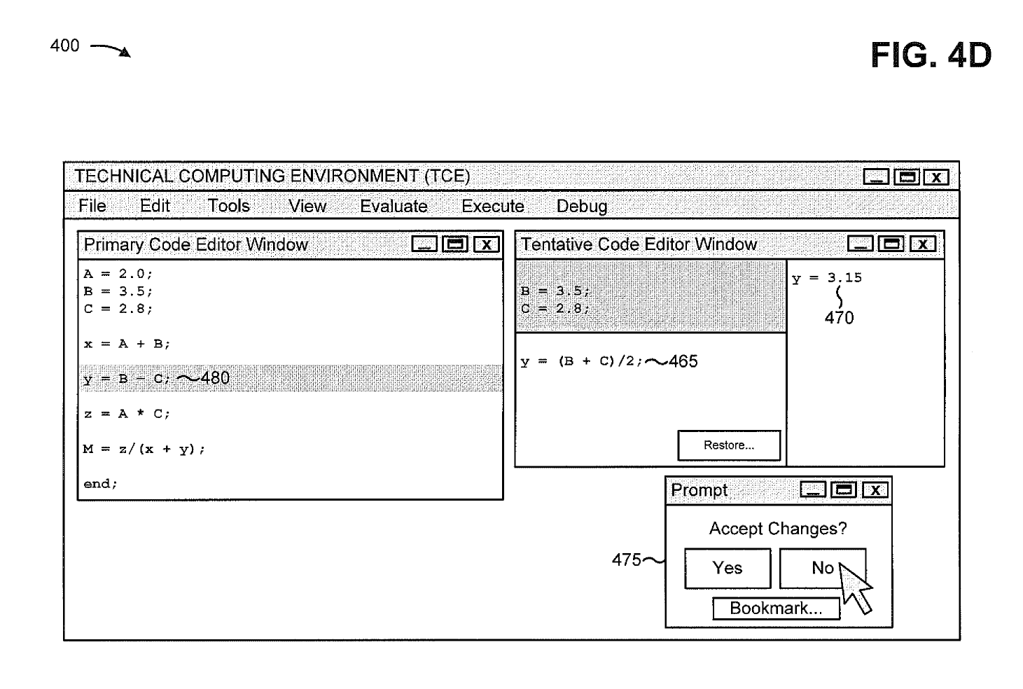

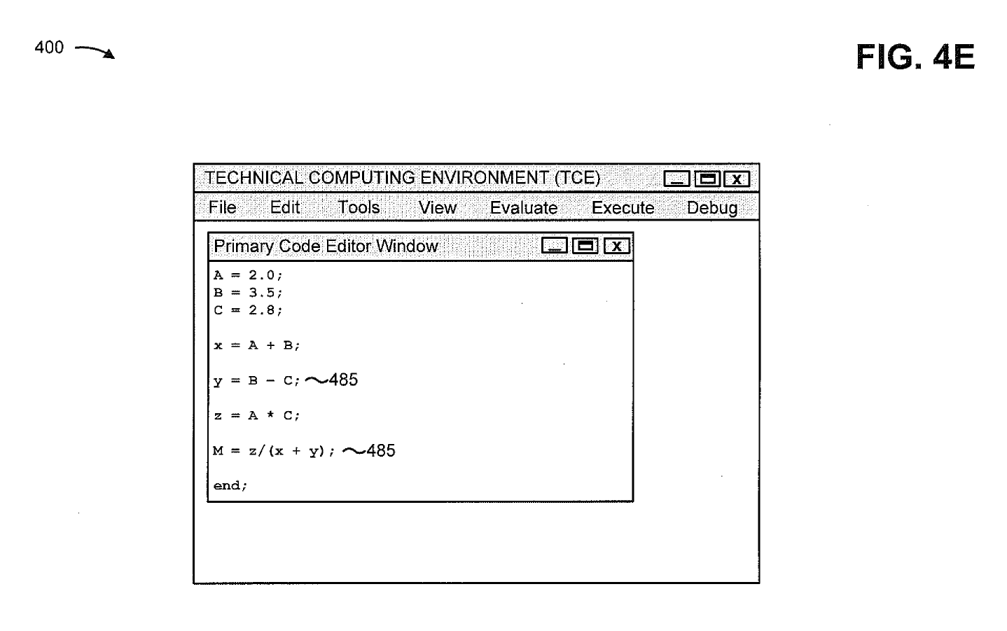

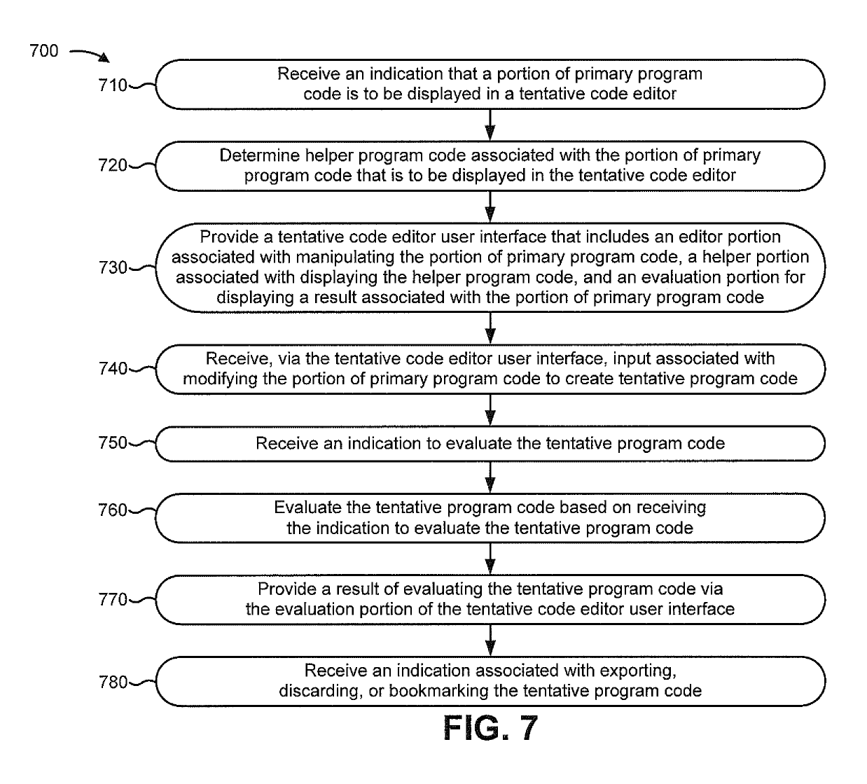

FIGS. 4A-4E are diagrams of an example implementation 400 relating to the example process 700 shown in FIG. 7. For the purposes of example implementation 400, assume that a user has provided primary code via a primary editor window associated with a technical computing environment, identified as TCE. Primary program code may include program code associated with a primary editor associated with TCE 220. Further, assume that the user wishes to modify a portion of the primary code to create tentative code, but that the user wishes to see a result associated with the tentative code before including the tentative code in the primary code. Finally, assume that the TCE is capable of providing a tentative editor that allows the user to modify the primary code portion to create tentative code and view a result, associated with the tentative code, without modifying the primary code portion in the primary editor.

As shown in FIG. 4A, and by reference number 405, TCE may receive an indication that the user wishes to copy a first line of primary code (e.g., M=z/(x×y);) to the tentative editor (e.g., when the user double clicks the first line of primary code in the primary editor).

As shown, TCE may determine helper code (e.g., x=5.5, y=0.7, z=5.6), associated with the first line of primary code based on evaluating the primary code in the primary editor (e.g., since A=2.0, B=3.5, C 2.8, x=A+B, y=B−C, and z=A×C, then x=5.5, y=0.7, and z=5.6). Helper code may include program code associated with a dependency of the primary code portion that is to be displayed in the tentative editor.

As shown, TCE may determine a result (e.g., M=1.45) associated with the first line of primary code by evaluating the first line of primary code based on the helper code (e.g., since M=z/(x x y)=5.6/(5.5×0.7)=1.45). As shown by reference number 410, TCE may display a tentative editor window including an editor portion that includes the first line of primary code. As shown by reference number 415, TCE may also display a helper code portion of the tentative editor window that includes the helper code associated with the first line of primary code. As shown by reference number 420, TCE may further display an evaluation portion of the tentative editor window that includes the result associated with the first line of primary code.

As shown in FIG. 4B, and by reference number 425, TCE may receive, from the user and via the editor portion of the tentative editor window, input associated with modifying the first line of the primary code. As shown, the user may modify the first line of primary code to create a first line of tentative code (e.g., M=z/(x+y);). For the purposes of example implementation 400, assume that TCE is configured to update the evaluation portion of the tentative editor window in real-time (e.g., as the user provides input to the editor portion of the tentative editor). As shown by reference number 430, TCE may evaluate the first line of tentative code (e.g., based on the helper code) to determine a result associated with the first line of tentative code, and may display the result in the evaluation portion of the tentative editor window (e.g., M=z/(x+y)=5.6/(5.5+0.7)=0.9). As shown, the editor portion may also include an input element (e.g., a button) that allows the user to indicate that the tentative editor window is to restore the first line of primary code and/or restore a particular version of the tentative code created by the user (e.g., after the user modifies the first line of primary code and when TCE is configured to store one or more versions of the tentative code).

As shown, assume that the user is satisfied with the tentative result of the first line of tentative code, and that the user provides an indication (e.g., by selecting a menu item, by right clicking the tentative code, etc.) that the user is finished modifying the first line of primary code. As shown by reference number 435, TCE may prompt the user to indicate whether the tentative code is to be accepted. As shown, the user may indicate (e.g., by clicking a Yes button) that the tentative code is to be accepted and exported in to the primary code. As shown by reference number 440, TCE may replace (e.g., within the primary editor) the first line of primary code, in the primary editor, with the first line of tentative code based on the indication that the tentative code is to be exported.

As shown in FIG. 4C, and by reference number 445, TCE may receive an indication that the user wishes to copy a second line of primary code (e.g., y=B−C) to the tentative editor (e.g., when the user double clicks the second line of primary code in the primary editor). As shown, TCE may determine helper code (e.g., B=3.5, C=2.8), associated with the second line of primary code based on other primary code in the primary editor (e.g., since the primary code indicates that B=3.5 and C=2.8). As shown, TCE may determine a result (e.g., y=0.7) associated with the second line of primary code by evaluating the second line of primary code based on the helper code (e.g., since y=B−C=3.5−2.8=0.7). As shown by reference number 450, TCE may display a tentative editor window including an editor portion that includes the second line of primary code. As shown by reference number 455, TCE may also display a helper code portion of the tentative editor window that includes the helper code associated with the second line of primary code. As shown by reference number 460, TCE may further display an evaluation portion of the tentative editor window that includes the result associated with the second line of primary code.

As shown in FIG. 4D, and by reference number 465, TCE may receive, from the user and via the editor portion of the tentative editor window, input associated with modifying the second line of the primary code. As shown, the user may modify the second line of primary code to create a second line of tentative code (e.g., y=(B+C)/2). As shown by reference number 470, TCE may evaluate the second line of tentative code (e.g., based on the helper code) to determine a tentative result associated with the second line of tentative code, and may display the tentative result in the evaluation portion of the tentative editor window (e.g., y=(B+C)/2=(3.5+2.8)/2=3.15).

As shown, assume that the user is not satisfied with the tentative result of the second line of tentative code, and that the user provides an indication (e.g., by selecting a menu item, by right clicking the tentative code, etc.) that the user is finished modifying the second line of primary code. As shown by reference number 475, TCE may prompt the user to indicate whether the tentative code is to be accepted. As shown, the user may indicate (e.g., by clicking a No button) that the tentative code is not to be accepted and is to be discarded. As shown by reference number 480, TCE may discard the second line of tentative code without modifying the second line of primary code in the primary editor window.

As shown in FIG. 4E, and by reference number 485, TCE may close the tentative editor window, and may display the primary editor window. Notably, the primary code includes the first line of tentative code (e.g., M=z/(x+y)), but does not include the second line of tentative code (e.g., y==(B+C)/2).

As indicated above, FIGS. 4A-4E are provided merely as an example. Other examples are possible and may differ from what was described with regard to FIGS. 4A-4E.

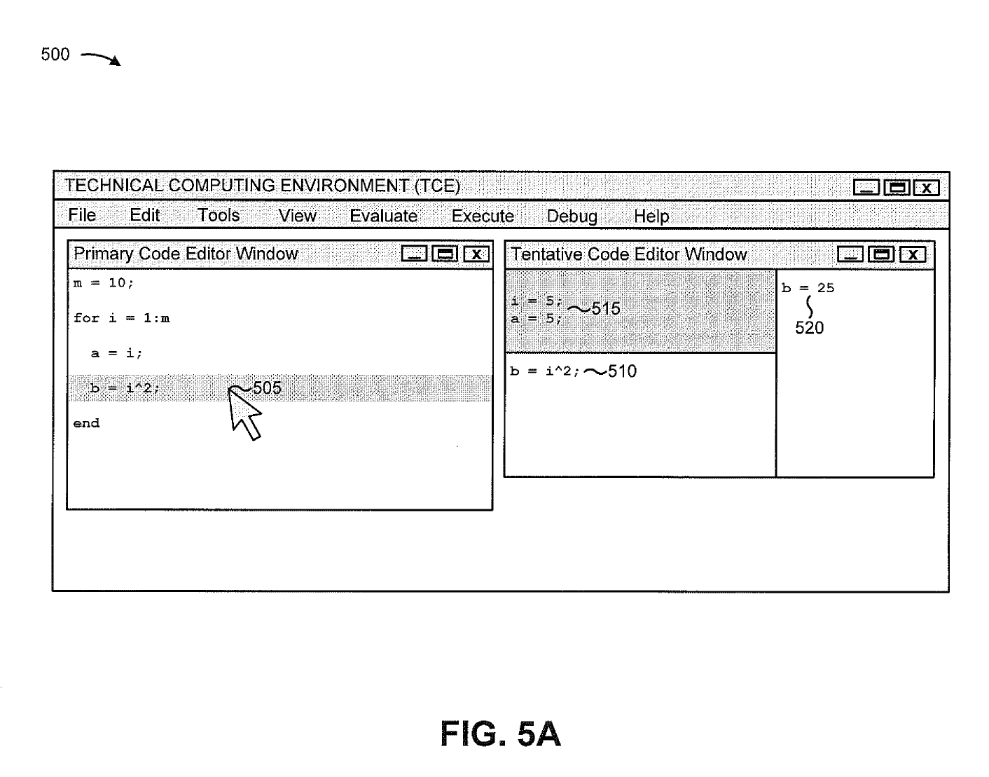

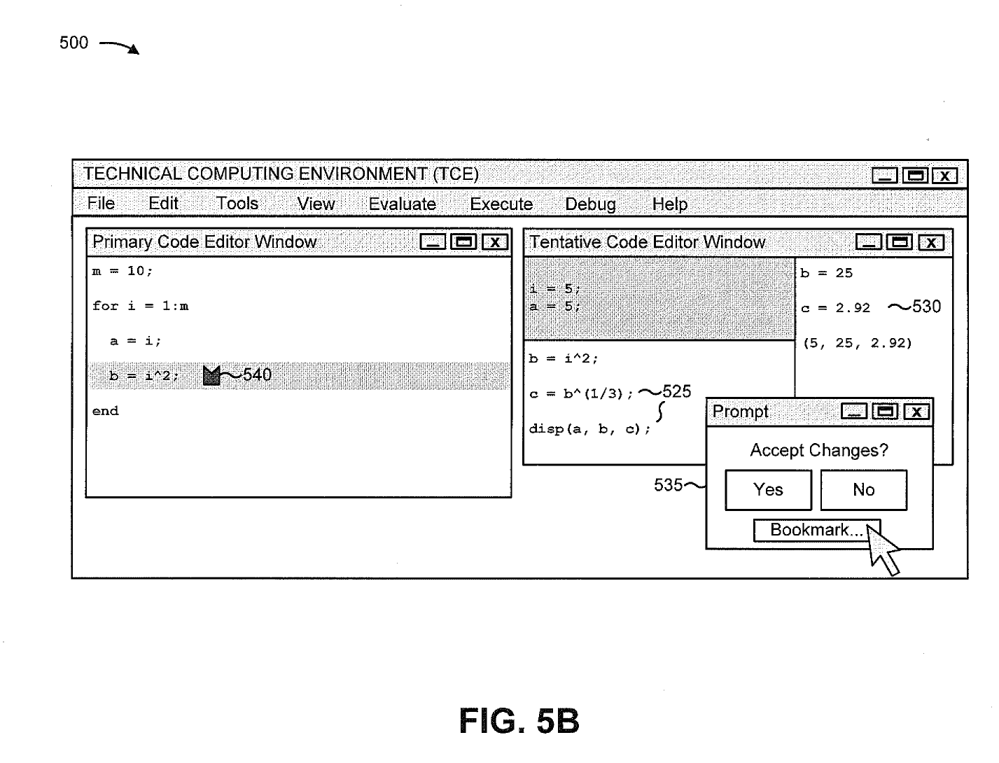

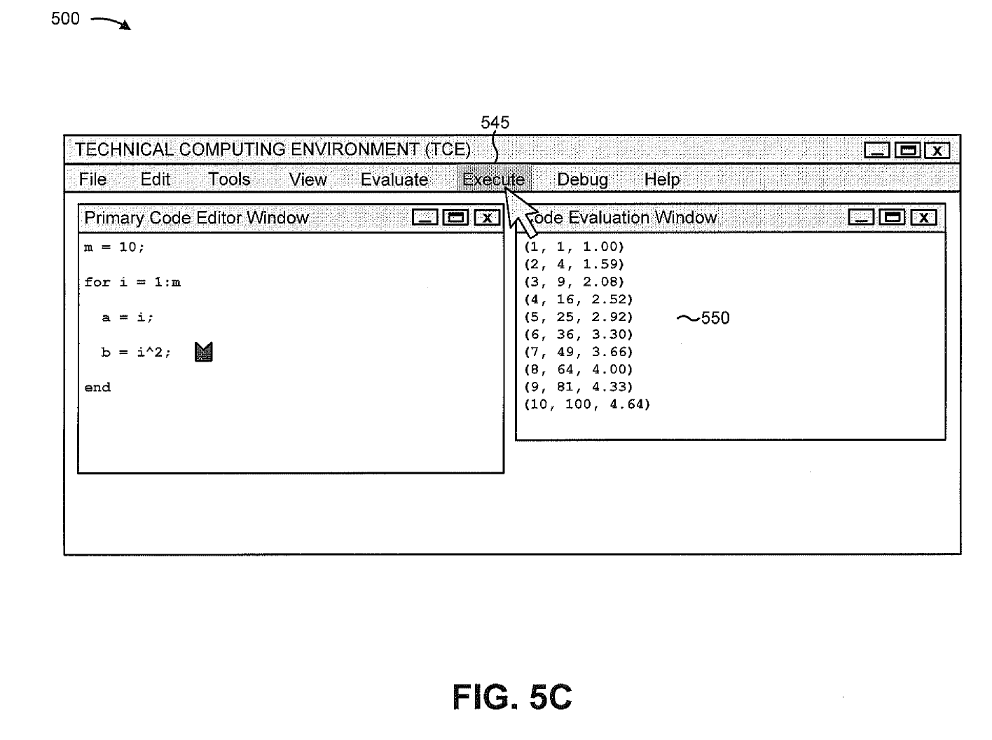

FIGS. 5A-5C are diagrams of an additional example implementation 500 relating to the example process 500 shown in FIG. 5. For the purposes of example implementation 500, assume that a user has provided primary code via a primary editor window associated with a technical computing environment, identified as TCE. Further, assume that the user wishes to modify a portion of the primary code to create tentative code, but that the user wishes to see a result associated with the tentative code before including the tentative code in the primary code. Finally, assume that the TCE is capable of providing a tentative editor that allows the user to modify the primary code portion to create tentative code and view a result, associated with the tentative code, without modifying the primary code portion in the primary editor.

As shown in FIG. 5A, and by reference number 505, TCE may receive an indication that the user wishes to copy a line of primary code (e.g., b=î2) to the tentative editor (e.g., when the user double clicks the line of primary code in the primary editor). As shown, assume that TCE determines helper code (e.g., i=5, a=5) associated with the line of primary code. As shown, TCE may determine a result (e.g., b=25) associated with the line of primary code by evaluating the line of primary code based on the helper code (e.g., since b=î2=5̂2=25). As shown by reference number 510, TCE may display a tentative editor window including an editor portion that includes the line of primary code. As shown by reference number 515, TCE may also display a helper code portion of the tentative editor window that includes the helper code associated with the line of primary code. As shown by reference number 520, TCE may further display an evaluation portion of the tentative editor window that includes the result associated with the line of primary code.

As shown in FIG. 5B, and by reference number 525, TCE may receive, from the user and via the editor portion of the tentative editor window, input associated with modifying the line of the primary code. As shown, the user may modify the line of primary code (e.g., by adding additional program code) to create tentative code (e.g., c=b̂(1/3);, disp (a,b,c);). For the purposes of example implementation 500, assume that TCE is configured to update the evaluation portion of the tentative editor window in real-time (e.g., as the user provides input to the editor portion of the tentative editor). As shown by reference number 530, TCE may evaluate the tentative code (e.g., based on the helper code) to determine a tentative result (e.g., b=25, c=2.92, (5, 25, 2.92)) associated with the tentative code, and may display the tentative result in the evaluation portion of the tentative editor window.

As shown, assume that the user is satisfied with the tentative result of the tentative code, and that the user provides an indication (e.g., by selecting a menu item, by right clicking the tentative code, etc.) that the user is finished modifying the line of primary code. As shown by reference number 535, TCE may prompt the user to indicate whether the tentative code is to be accepted. As shown, the user may indicate (e.g., by clicking a Bookmark button) that the tentative code is to be accepted and is to be associated with the line of primary code, in the primary editor, in the form of a bookmark. For the purpose of example implementation 500, assume that bookmarked program code is to be executed each time that a line of primary code is executed, but that the bookmarked program code is not to be include in the primary code. As shown by reference number 540, TCE may display an indication (e.g., a bookmark icon) in close proximity to the line of primary code associated with the bookmarked tentative code.

As shown in FIG. 5C, and by reference number 545, TCE may receive an indication (e.g., by selecting an Execute menu item) that the user wishes TCE to execute the primary code. As shown by reference number 550, TCE may execute the primary code (e.g., including the bookmarked tentative code) and may provide (e.g., via a code evaluation window) a result associated with executing the primary code and the tentative code. Notably, the result includes a result associated with the bookmarked tentative code, even though the tentative code is not included in the primary code.

As indicated above, FIGS. 5A-5C are provided merely as an example. Other examples are possible and may differ from what was described with regard to FIGS. 5A-5C.

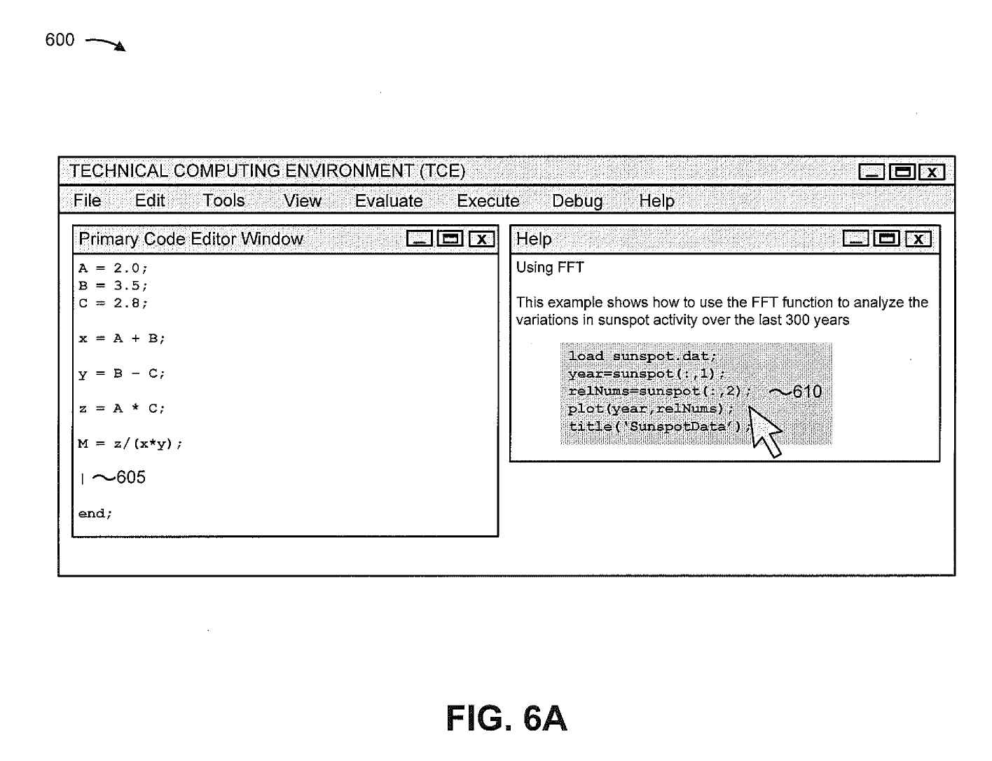

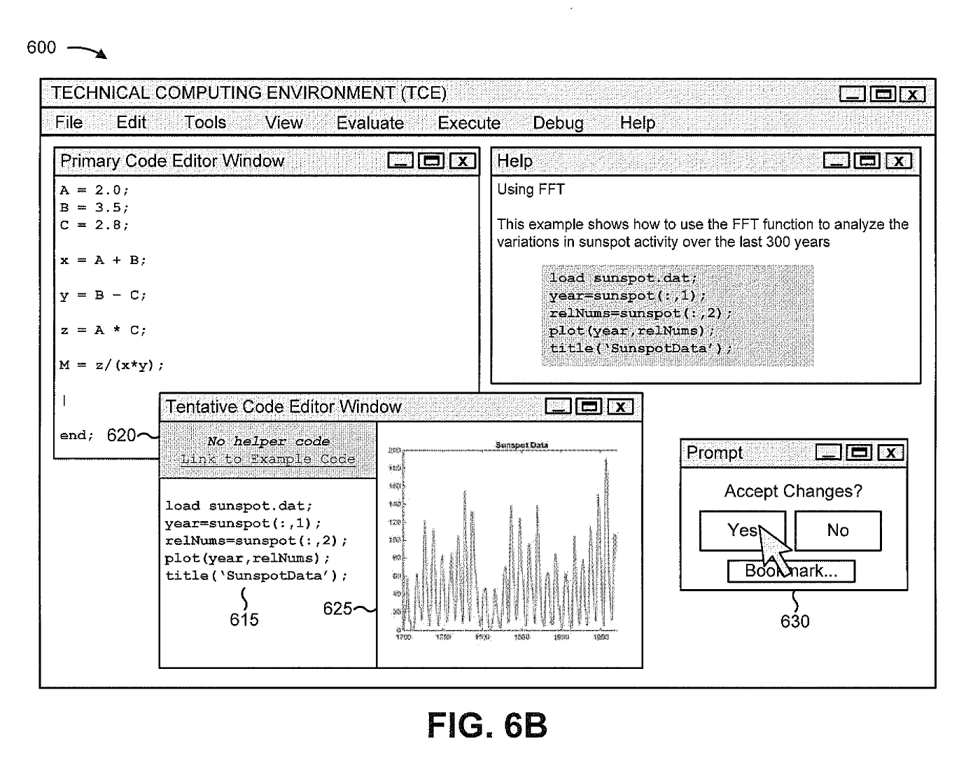

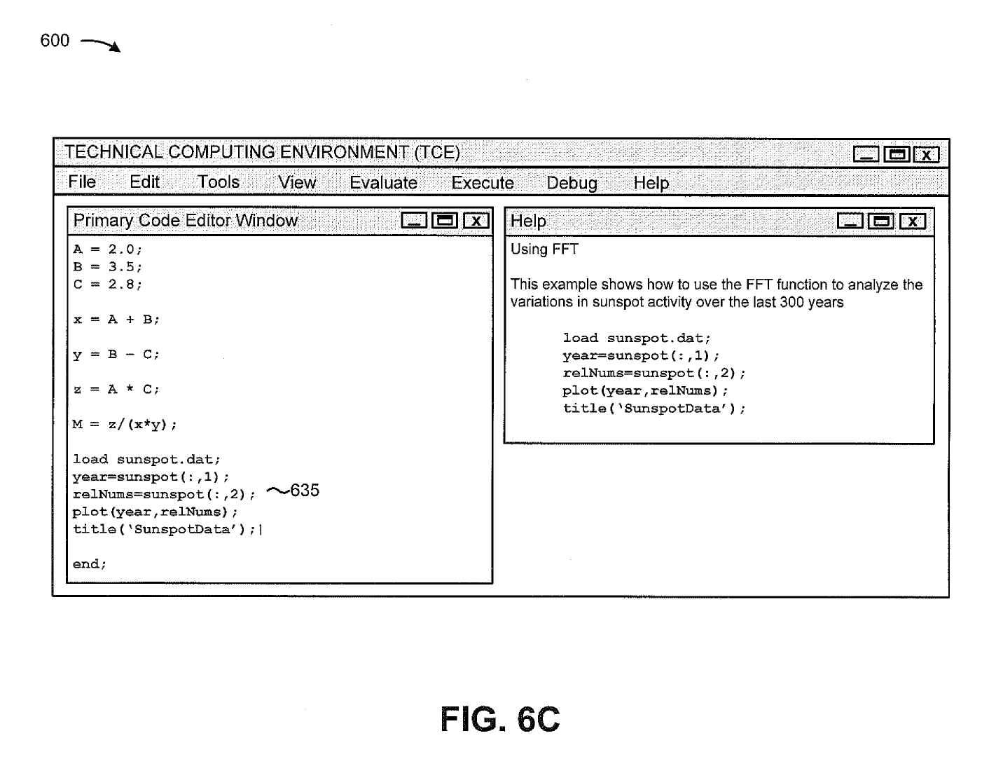

FIGS. 6A-6C are diagrams of another example implementation 600 relating to the example process 700 shown in FIG. 7. For the purposes of example implementation 600, assume that a user has provided primary code via a primary editor window associated with a technical computing environment, identified as TCE. Further, assume that the user is viewing a help window, associated with TCE, that includes example primary code that the user wishes to incorporate into the primary code. Finally, assume that the TCE is capable of providing a tentative editor that allows the user to modify the example primary code to create tentative code and view a result, associated with the tentative code, without incorporating the tentative code in to primary code.

As shown in FIG. 6A, and by reference number 605, the user may position a cursor, associated with the primary editor, at a particular location in the primary editor window (e.g., such that tentative code may be inserted at the location of the cursor). As shown by reference number 610, TCE may receive an indication the user wishes to view the example primary code (e.g., program code associated with sunspot data) in the tentative editor (e.g., when the user double clicks the example primary code in the help window). In other words, TCE may receive an indication that the user wishes to copy (e.g., without editing) the example primary code from the help window into the tentative code editor

As shown in FIG. 6B, TCE may determine a result (e.g., a sunspot data plot) associated with the example primary code. As shown by reference number 615, TCE may display a tentative editor window including an editor portion that includes the example primary code. As shown by reference number 620, TCE may also display a helper portion of the tentative editor window that includes helper code associated with the example primary code. For the purposes of example implementation 600, assume that TCE determines that no helper code is necessary to evaluate the example primary code. As shown, the helper portion may include an input element (e.g., a hyperlink) associated with the source of the example primary program code that, if selected, causes TCE to display a source of the example primary code (e.g., the help window).

As shown by reference number 625, TCE may also display an evaluation portion of the tentative editor window that includes the result associated with evaluating the example primary code. As shown, the user may choose not to modify the example program code in the tentative editor window (e.g., the user is satisfied with the result of the example primary code). As such, in this example, the tentative code is identical to the example primary code.

As further shown, assume that the user provides an indication (e.g., by selecting a menu item, by right clicking the tentative code, etc.) that the user is finished modifying the example primary code (e.g., with no modifications, as discussed above). As shown by reference number 630, TCE may prompt the user to indicate whether the tentative code is to be accepted. As shown, the user may indicate (e.g., by clicking a Yes button) that the tentative code is to be accepted and exported in to the primary code.

As shown in FIG. 6C, and by reference number 635, TCE may add (e.g., within the primary editor) the tentative code (e.g., the example primary code) to the primary editor window at the particular location associated with the cursor.

As indicated above, FIGS. 6A-6C are provided merely as an example. Other examples are possible and may differ from what was described with regard to FIGS. 6A-6C.

FIG. 7 is a flow chart of an example process 700 for receiving tentative code via a tentative editor and receiving information associated with exporting, discarding, or bookmarking the tentative code. In some implementations, the process blocks of FIG. 7 may be performed by user device 210. In some implementations, one or more process blocks of FIG. 7 may be performed by another device or a group of devices separate from or including user device 210, such as server device 230.

As shown in FIG. 7, process 700 may include receiving an indication that a portion of primary code is to be displayed in a tentative editor (block 710). For example, user device 210 may receive (e.g., based on user input) an indication that a portion of primary program code (primary code portion), included in a primary editor, is to be displayed in a tentative editor. User device 210 may receive the indication based on a user interaction with a user interface of TCE 220, in some implementations. For example, a user may interact with an input mechanism (e.g., a menu item, a button, a double click on the primary code, etc.) to provide the indication to user device 210. In some implementations, the user may select (e.g., by clicking, by highlighting, etc.) the primary code portion and may indicate (e.g., by selecting a menu item, by clicking a button, etc.) that the primary code portion is to be displayed in the tentative editor, as shown in FIG. 4 by reference numbers 405 and 445, in FIG. 5 by reference number 505, and in FIG. 6 by reference number 610.

In some implementations, the primary code portion may include a portion of primary code (e.g., a character included in the primary code, a string of characters included in the primary code, a line of primary code, a group of lines of primary code, etc.) included in the primary editor. Additionally, or alternatively, the primary code portion may include a section of text associated with the primary code (e.g., a line of text included in the primary editor that starts with a particular string of characters, such as %%), a region associated with the primary code (e.g., a contiguous group of lines of primary code with that does not include any comments, whitespace, rich text, etc.), primary code that describes a function, a block of primary code (e.g., primary code associated with a conditional statement, primary code associated with a loop control statement, etc.), and/or another portion of the primary code.

In some implementations, the user may select the primary code portion, and primary code upon which the primary code portion depends may be automatically selected (e.g., by TCE 220). Additionally, or alternatively, the user may select the primary code portion, and primary code that depends on the primary code portion may be automatically selected (e.g., by TCE 220). In some implementations, the user may then deselect the automatically selected primary code (e.g., via a user interface provided by TCE 220).

Primary program code may include program code associated with a primary editor associated with TCE 220. In some implementations, the primary code may be provided to the primary editor by a user (e.g., via a primary editor user interface). Additionally, or alternatively, the primary code may be associated with a model element of a model (e.g., a block in a block diagram model, a portion of text in a textual model, etc.), and the user may interact with an element of the model (e.g., a block) to provide the indication that the program code is to be displayed in a tentative editor.

Program code (sometimes referred to herein as code), including primary code and tentative code, is to be broadly interpreted to include text-based code that may not require further processing to execute (e.g., C++ code, Hardware Description Language (HDL) code, very-high-speed integrated circuits (VHSIC) HDL (VHDL) code, Verilog code, Java code, another type of hardware and/or software based code that may be compiled and/or synthesized, etc.), binary code that may be executed (e.g., executable files that may be directly executed by an operating system, bitstream files that may be used to configure an FPGA, Java byte code, object files combined together with linker directives, source code, makefiles, etc.), text files that may be executed in conjunction with other executables (e.g., Python text files, Octave files, a collection of dynamic-link library (DLL) files with text-based combining, configuration information that connects pre-compiled modules, an extensible markup language (XML) file describing module linkage, etc.), source code (e.g., readable by a human), machine code (e.g., readable by a machine), or the like.

In some implementations, program code may include different combinations of the above-identified classes of code (e.g., text-based code, binary code, text files, source code, machine code, etc.). Additionally, or alternatively, program code may include code generated using a dynamically-typed programming language (e.g., the M language, a MATLAB® language, a MATLAB-compatible language, a MATLAB-like language, etc.) that may be used to express problems and/or solutions using mathematical notations. Additionally, or alternatively, program code may be of any type, such as a function, a script, an object, etc.

In some implementations, a tentative editor may allow the user to manipulate the primary code portion to create tentative code without modifying the primary code portion in the primary editor. For example, user device 210 may receive the indication, may display the primary code portion in the tentative editor, and the user may manipulate the primary code portion within the tentative editor to create tentative program, as discussed below. For example a user may modify, alter, edit, delete, test, experiment with, etc. tentative code without altering a primary code portion. Thus, the tentative editor may allow the user to experiment with a portion of the primary code without affecting the primary code in the primary editor.

As further shown in FIG. 7, process 700 may include determining helper code associated with the primary code portion that is to be displayed in the tentative editor (block 720). For example, user device 210 may determine helper code associated with the primary code portion that is to be displayed in the tentative editor. In some implementations, user device 210 may determine the helper code when user device 210 receives the indication that the primary code portion is to be displayed in the tentative editor (e.g., after user device 210 receives the indication that the primary code portion is to be displayed in the tentative editor).

Helper code may include program code associated with a dependency of the primary code portion that is to be displayed in the tentative editor. For example, assume that the primary code portion that is to be displayed in the tentative editor includes information that identifies variables (e.g., y=x+4). In this example, helper code may include program code that identifies a value associated with one or more of the variables (e.g., x=5) on which the primary code portion depends. In some implementations, the helper code may be used to evaluate program code within the tentative editor. For example, if the primary code portion that is to be displayed is “y=x+4,” and the helper code is “x=5,” then the helper code may be used by the tentative editor to evaluate the primary code portion (e.g., y=5+4=9).

In some implementations, user device 210 (e.g., TCE 220) may determine the helper code by analyzing the primary code. For example, user device 210 may receive the indication to display the primary code portion in the tentative editor and TCE 220 may analyze the primary code to determine the helper code. In some implementations, the helper code may include other program code included in the primary editor (e.g., the helper code may include one or more other lines of program code included in the primary editor). Additionally, or alternatively, the helper code may be provided by the user (e.g., the user may provide, via the tentative editor, information that identifies the helper code).

In some implementations, the helper code may be updated based on input provided by the user. For example, the helper code may include information associated with a first variable (e.g., x=5) based on the first variable being included in the primary code (e.g., y=x+4). If the user modifies the primary code portion to include a second variable (e.g., y=z+4), then TCE 220 may determine helper code associated with the second variable (e.g., z=2), and may update the helper code, accordingly.

In some implementations, the helper code may include information that identifies a required variable, such as a variable that is included in the primary code portion that is to be displayed in the tentative editor. Additionally, or alternatively, the helper code may include information that identifies an available variable, such as a variable that is not is included in the primary code portion that is to be displayed in the tentative editor (e.g., but is included in other primary code not selected by the user), that may be added, by the user, to the primary code portion displayed in the tentative editor.

As further shown in FIG. 7, process 700 may include providing a tentative editor user interface that includes an editor portion associated with manipulating the primary code portion, a helper portion associated with displaying the helper code, and an evaluation portion for displaying a result associated with the primary code portion (block 730). For example, user device 210 may provide, via TCE 220, a tentative editor user interface that includes an editor portion (e.g., an editor window including the primary code portion) associated with manipulating the primary code portion to create tentative code, a helper portion (e.g., a helper code window including the helper code) associated with displaying the helper code, and an evaluation portion (e.g., an evaluation window) for displaying a result of evaluating the primary code portion and/or tentative code created based on modifying the primary code portion, as shown in FIG. 4 by reference numbers 410 through 420 and 450 through 460, in FIG. 5 by reference numbers 510 through 520, and in FIG. 6 by reference numbers 615 though 625.

In some implementations, user device 210 may provide the tentative editor user interface within the primary editor user interface. For example, user device 210 may determine (e.g., based on user input, based on a configuration of user device 210, etc.) an area included in the primary editor user interface (e.g., an area at the bottom of the primary editor user interface, an area between two lines of primary code displayed in the primary editor user interface, etc.), and user device 210 may provide the tentative editor user interface within the region. Alternatively, user device 210 may provide the tentative editor user interface in a window separate from the primary editor user interface.

In some implementations, TCE 220 may evaluate the primary code portion when user device 210 provides the tentative editor user interface, and TCE 220 may provide a result of evaluating the primary code portion in the evaluation portion of the tentative editor user interface (e.g., such that the result associated with evaluating the primary code portion is displayed when user device 210 initially provides the tentative editor user interface).

In some implementations, user device 210 may concurrently provide the editor portion, the helper portion, and the evaluation portion via the user interface (e.g., the portions may be displayed on the user interface at the same time). In some implementations, user device 210 may provide the editor portion, the helper portion, and the code evaluation portion side-by-side. Additionally, or alternatively, user device 210 may provide the editor portion, the helper portion, and the evaluation portion in another manner (e.g., top to bottom). In some implementations, user device 210 may provide the editor portion, the helper portion, and the evaluation portion within the same user interface. Additionally, or alternatively, user device 210 may provide the editor portion, the helper portion, and the evaluation portion in separate user interfaces.

In some implementations, user device 210 may provide the evaluation portion and the editor portion within a single window included in the tentative editor user interface. For example, the evaluation portion may be in a window that includes the editor portion. Additionally, or alternatively, user device 210 may provide the evaluation portion and the editor portion in separate windows included in the tentative editor user interface. For example, user device 210 may provide the editor portion within a first window included in the tentative editor user interface, and may provide the evaluation portion within a second window included in the tentative editor user interface. Additionally, or alternatively, user device 210 may provide the evaluation portion and the editor portion in multiple windows included in the tentative editor user interface. For example, user device 210 may provide the editor portion within a first window, and may provide the evaluation portion within a second window, a third window, and a fourth window, etc. In some implementations, the evaluation portion may include a figure window, an output panel, a tool tip window (e.g., a window that appears while the user causes a cursor, associated with the tentative editor, to hover over a variable included in the tentative editor), a command window, and/or another type of window. Additionally, or alternatively, the evaluation portion may be provided in another manner.

As further shown in FIG. 7, process 700 may include receiving, via the tentative editor user interface, input associated with modifying the primary code portion to create tentative code (block 740). For example, user device 210 may receive, via the tentative editor user interface, input associated with modifying the primary code portion to create tentative code. In some implementations, user device 210 may receive the input when user device 210 (e.g., TCE 220) provides the tentative editor user interface (e.g., after user device 210 provides the tentative editor user interface).

In some implementations, the user may provide the input via the editor portion of the tentative editor user interface, as shown in FIG. 4 by reference numbers 425 and 465, and in FIG. 5 by reference number 525. For example, the user may provide the input to the editor portion of the tentative editor user interface via a keyboard of user device 210, a touch screen of user device 210, a mouse associated with user device 210, or another input mechanism. In some implementations, the input may indicate a manner in which the primary code portion is to be manipulated to create tentative code. For example, the input may indicate that additional program code is to be added to the primary code portion. As another example, the input may indicate that the primary code portion is to be modified in another manner (e.g., that a first function, included in the primary code portion, is to be replaced with a second function, etc.).

As further shown in FIG. 7, process 700 may include receiving an indication to evaluate the tentative code (block 750). For example, user device 210 may receive an indication to evaluate (e.g., an evaluation indicator) the tentative code created via the editor portion of the tentative editor user interface.

In some implementations, user device 210 may receive the evaluation indicator based on a user interaction with a user interface of TCE 220. For example, a user may interact with an input mechanism (e.g., a menu item, a button, a tool bar item, a gesture, an interaction with a touch screen, etc.) to provide the evaluation indicator to user device 210. Additionally, or alternatively, user device 210 may receive the evaluation indicator based on the user providing the input that modifies the program code to create the tentative code. For example, the user may provide the input that modifies the program code to create tentative code, and user device 210 may receive the evaluation indicator based on the user providing the input such that user device 210 receives the evaluation indicator and evaluates the tentative code, in real-time, as the user modifies the program code. Real-time can refer to a time interval, such as an elapsed time during execution of code, that is of a duration that does not inconvenience the user and/or interfere with the user performing a desired task. For example, if a program executes in 1 ms, 10 ms, or 500 ms, that time may be fast enough, from the user's standpoint, such that it constitutes real-time in that this interval does not interfere with the user doing a desired task.

Additionally, or alternatively, user device 210 may receive the evaluation indicator based on a threshold length of time. For example, the user may provide the input that modifies the portion of program code to create the tentative code, and user device 210 may not detect another user interaction, associated with modifying the primary code portion, for a length of time. In this example, if the length time satisfies a threshold length of time, user device 210 may automatically receive the evaluation indicator.

In some implementations, the evaluation indicator may include an indication to evaluate the tentative code created in the editor portion of the tentative editor user interface based on the helper code included in the helper portion of the tentative editor user interface.

As further shown in FIG. 7, process 700 may include evaluating the tentative code based on receiving the indication to evaluate the tentative code (block 760). For example, user device 210 may evaluate the tentative code based on receiving the indication to evaluate the tentative code. In some implementations, user device 210 may evaluate the program code by executing the tentative code based on the helper code. Additionally, or alternatively, user device 210 may provide information identifying the tentative code and the helper code to one or more server devices 230 for evaluation (e.g., serially or in parallel). Server device(s) 230 may evaluate the tentative code based on the helper code, and may provide a result of evaluating the tentative code to user device 210.

As further shown in FIG. 7, process 700 may include providing a result of evaluating the tentative code via the evaluation portion of the tentative editor user interface (block 770). For example, user device 210 may provide a result of evaluating the tentative code via the evaluation portion of the tentative editor user interface provided via TCE 220. In some implementations, the result may include a result of executing the tentative code, such as a numerical result, a textual result, a figure, a plot, a graph, a table, a list, and/or another kind of result, as shown in FIG. 4 by reference numbers 430 and 470, and in FIG. 5 by reference number 530. In some implementations, the result may include multiple results that each correspond to a particular portion of the tentative code (e.g., a numerical result and a figure, a table and a plot, etc.).

As further shown in FIG. 7, process 700 may include receiving an indication associated with exporting, discarding, or bookmarking the tentative code (block 780). For example, user device 210 may receive an indication associated with exporting, discarding, or bookmarking the tentative code. In some implementations, user device 210 may receive the indication after user device 210 provides the result of evaluating the tentative code (e.g., after the user has viewed the result in the evaluation portion of the tentative editor user interface).

In some implementations, user device 210 may receive the indication based on a user interaction with a user interface of TCE 220. For example, a user may interact with an input mechanism (e.g., a menu item, a button, a tool bar item, a gesture, an interaction with a touch screen, etc.) to provide the indication to user device 210.

In some implementations, the indication may indicate that user device 210 is to export the tentative code, as shown in FIG. 4 by reference number 435 and in FIG. 6 by reference number 630. For example, the user may be satisfied with the result displayed by the evaluation portion of the tentative editor user interface, and the user may provide an indication that TCE 220 is to export the tentative code from the tentative editor to the primary editor associated with the primary code portion. In other words, the indication may indicate that TCE 220 is to export the tentative code when the user wishes to accept the modifications that created the tentative code. In some implementations, TCE 220 may export the tentative code to the primary editor, and may replace the primary code portion with the tentative code. Additionally, or alternatively, TCE 220 may export the tentative code to the primary editor and may add the tentative code to the primary code (e.g., without replacing the primary code portion).

In some implementations, the indication may indicate that user device 210 is to discard the tentative code, as shown in FIG. 4 by reference number 475. For example, the user may not be satisfied with the result displayed by the evaluation portion of the tentative editor user interface, and the user may provide an indication that TCE 220 is to discard the tentative code. In other words, the indication may indicate that TCE 220 is to discard the tentative code when the user does not wish to accept the modifications that created the tentative code. In some implementations, TCE 220 may discard the tentative code such that the primary code portion is unchanged.

In some implementations, the indication may indicate that the tentative editor is to restore the primary code portion. For example, the user may create first tentative code based on modifying a primary code portion, and may indicate (e.g., by selecting a button, by selecting a menu item, etc.) that the user is not satisfied with the first tentative program code and that the user wishes to for the tentative code editor to restore the primary code portion. In this example, user device 210 may cause the first tentative code to be replaced (e.g., within the editor portion) with the primary code portion such that the user may create second tentative code based on the primary code portion (e.g., when user device 210 is configured to store information associated with the primary code portion).

Additionally, or alternatively the indication may indicate that the tentative editor is to restore a previous version of the tentative code. For example, user device 210 may periodically (e.g., every 30 seconds, every 1 minute, etc.) store a version of the tentative code (e.g., while the user provides input associated with creating the tentative code). In this example, the user may create a first version of the tentative code, user device 210 may store the first version of the tentative code, and the user may revise the first version of the tentative code to create a second version of the tentative code. Here, the user may indicate (e.g., by selecting a button, by selecting a menu item, etc.) that user device 210 is to restore the first version of the tentative code, and user device 210 may restore the first version of the tentative code by replacing (e.g., within the editor portion of the tentative editor user interface) the second version of the tentative code with the first version of the tentative code.

In some implementations, the indication may indicate that user device 210 is to bookmark the tentative code, as shown in FIG. 5 by reference number 535. A bookmark, associated with tentative code, may include information indicating that the tentative code is to be associated with the primary code, but is not to be included in the primary code. For example, a bookmark, associated with tentative code, may indicate that the tentative code is to be executed at a particular point during execution of the primary code (e.g., when the portion of program code is executed). However, in this example, the tentative code may not be included in the primary code. Rather, the tentative code may be stored in another location (e.g., a bookmark file associated with TCE 220) and the tentative code may be read from the other location during execution of the primary code.

In some implementations, the bookmark may be associated with a particular line of primary code (e.g., the primary code portion), as described in the above example, and TCE 220 may display information indicating that the bookmark is associated with the line of primary code. For example, TCE 220 may display, within the primary editor, information (e.g., a bookmark icon, a note, an arrow, etc.) in close proximity to a line of primary code to indicate that a bookmark is associated with the line of primary code. In some implementations, TCE 220 may allow the user to move the bookmark (e.g., by clicking and dragging a bookmark icon, etc.) to another line of program code, such that the tentative code included in the bookmark may be executed when the other line of program code is executed. In some implementations, the tentative code may be associated with multiple bookmarks (e.g., the tentative code may be executed multiple times during execution of the primary code based on multiple bookmarks included in the primary code).

Additionally, or alternatively, the bookmark may be associated with satisfying a condition associated with the primary code. For example, TCE 220 may allow the user to configure the bookmark, associated with the tentative code, such that the tentative code is executed only when a threshold condition (e.g., a quantity of memory usage, a breakpoint, etc.), associated with executing the primary code, is satisfied. As another example, TCE 220 may allow the user to configure the bookmark, associated with the tentative code, such that the tentative code is be executed only when a variable, associated with executing the primary code satisfies a threshold condition (e.g., when the variable is equal to a specified numerical value, is greater than a specified numerical value, is less than a specified numerical value, etc.). In some implementations, the bookmark, associated with the condition, may be useful for debugging purposes. Additionally, or alternatively, the bookmark may be associated with satisfying a condition associated with a graphical programming environment, such as a Simulink model. For example, TCE 220 may allow the user to configure the bookmark such that the tentative code is executed only when a TCE 220 receives, from a Simulink model, an indication that the tentative code is to be executed.

In some implementations, user device 210 may receive the indication that user device 210 is to bookmark the tentative code, and user device 210 (e.g., TCE 220) may provide a bookmarking user interface that allows the user to configure the bookmark. For example, the bookmarking user interface may allow the user to specify (e.g., via one or more text boxes, check boxes, menu selections, drop down menus, mechanisms associated with selecting a line of primary code, etc.) one or more lines of primary code that are to be associated with the bookmark, one or more conditions associated with executing the tentative code associated with the bookmark, and/or another configuration associated with bookmarking the tentative code.

In this way, the user may select a primary code portion, included in a primary editor, and may manipulate, via a tentative editor, the primary code portion to create tentative code (e.g., without modifying the primary code portion in the primary editor). TCE 220 may then evaluate the tentative code and the user may choose to accept the tentative code (e.g., by exporting the tentative code to the primary code, by bookmarking the tentative code in the primary code), or may choose to discard the tentative code. In this manner, the user may modify, alter, edit, revise, text, and/or experiment with the tentative code prior to deciding whether to modify the primary code.

Although FIG. 7 shows example blocks of process 700, in some implementations, process 700 may include additional blocks, different blocks, fewer blocks, or differently arranged blocks than those depicted in FIG. 7. Additionally, or alternatively, two or more of the blocks of process 700 may be performed in parallel.

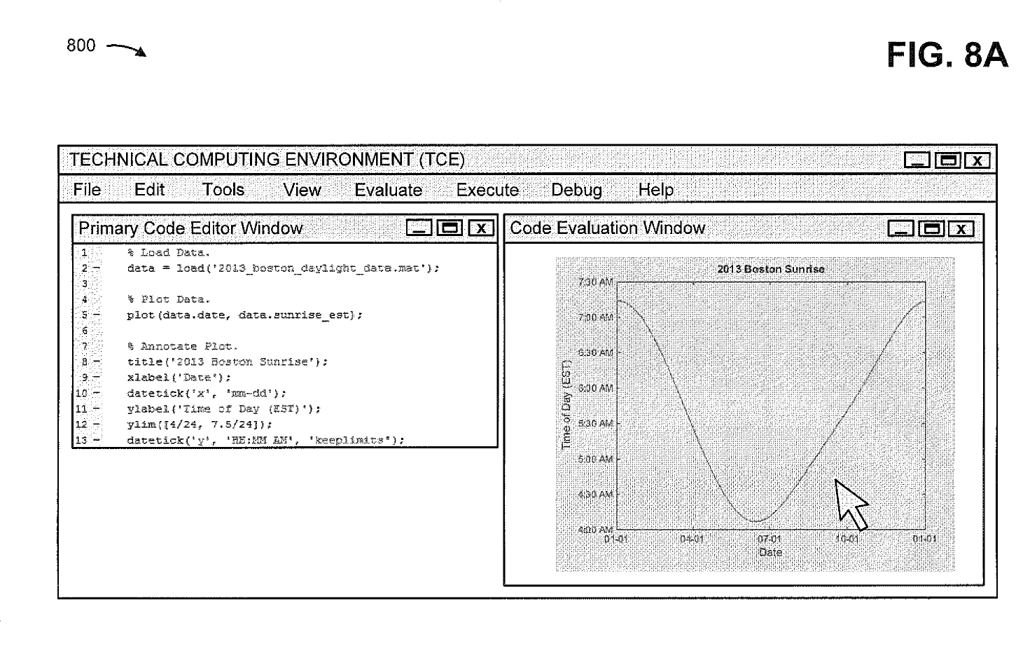

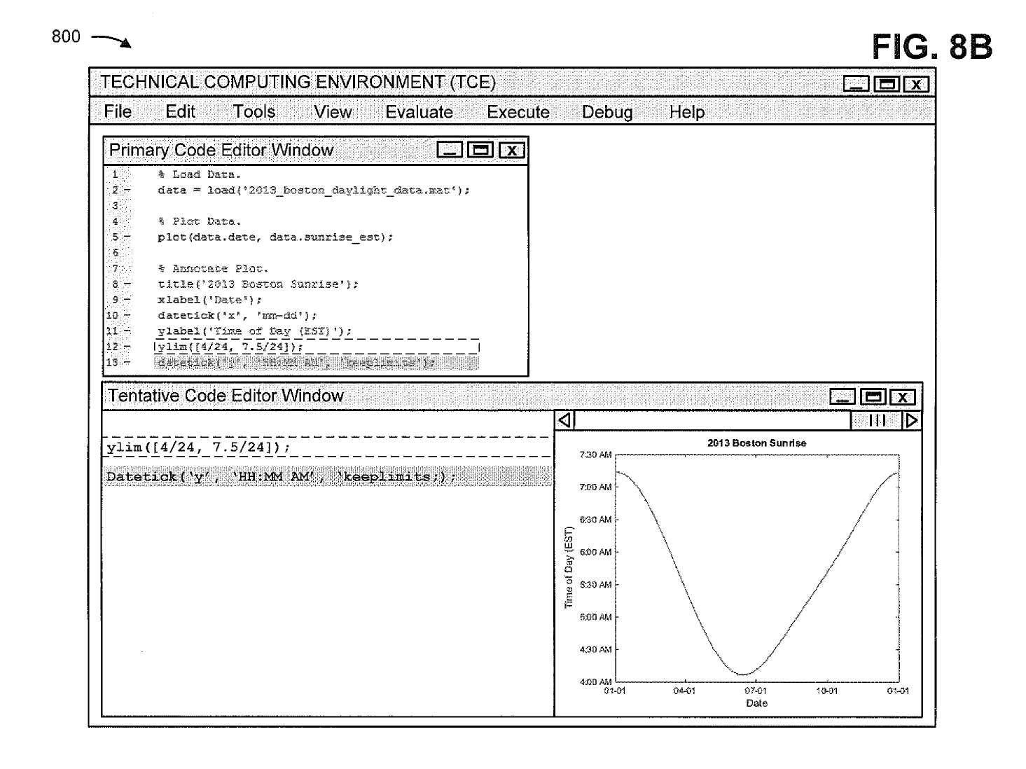

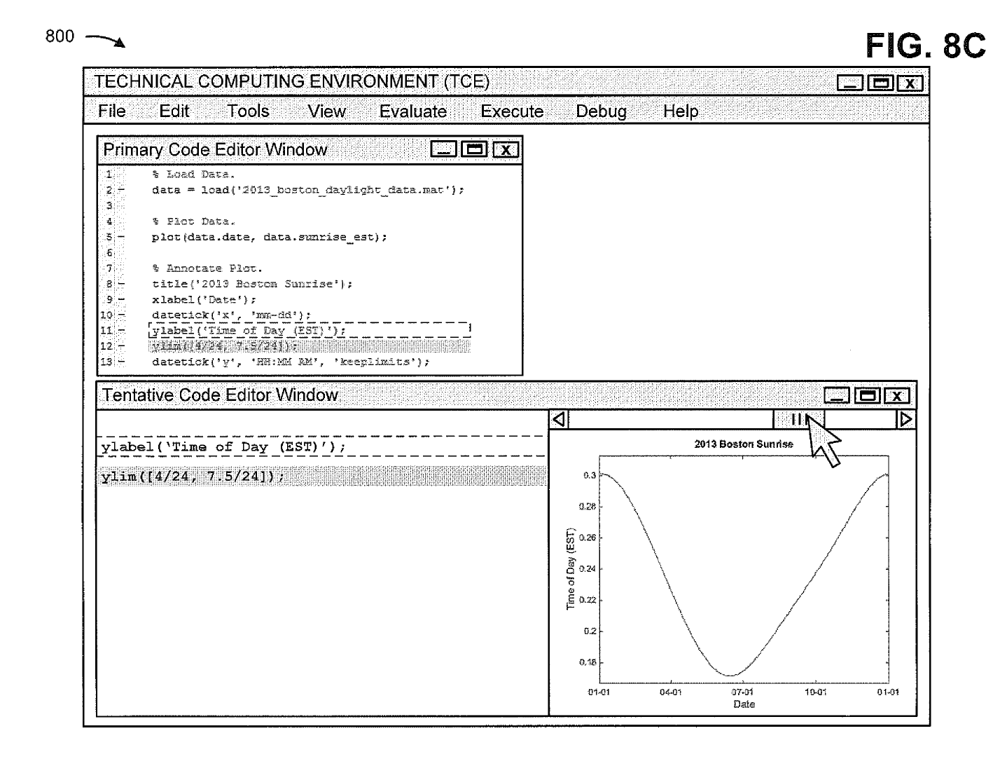

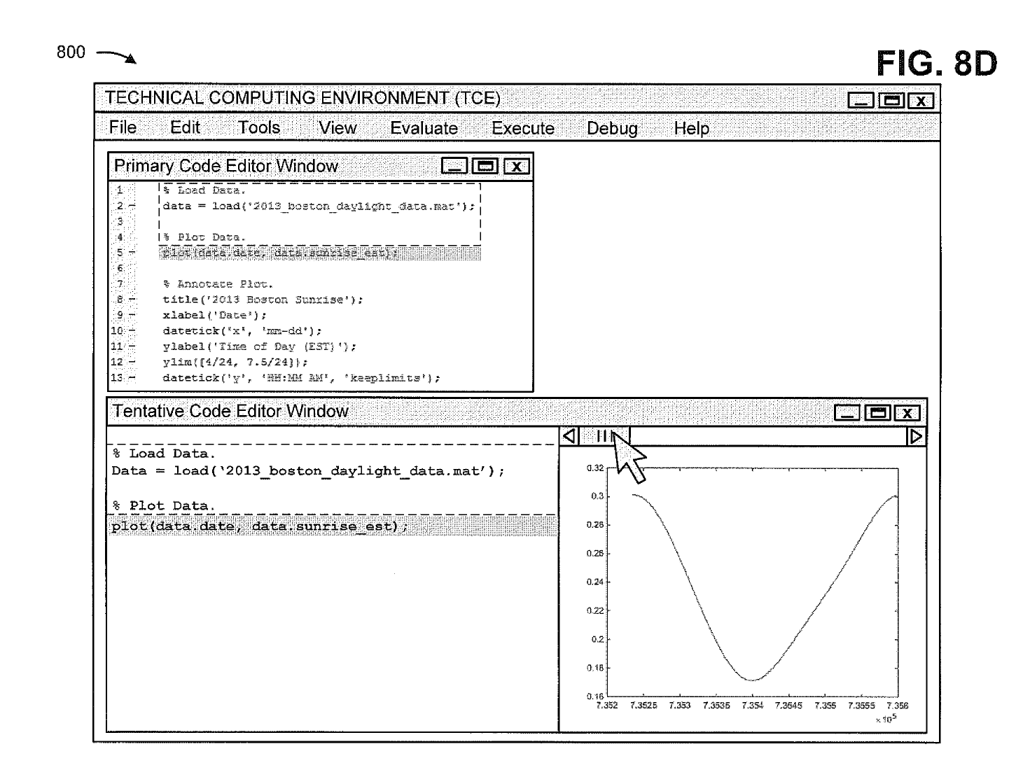

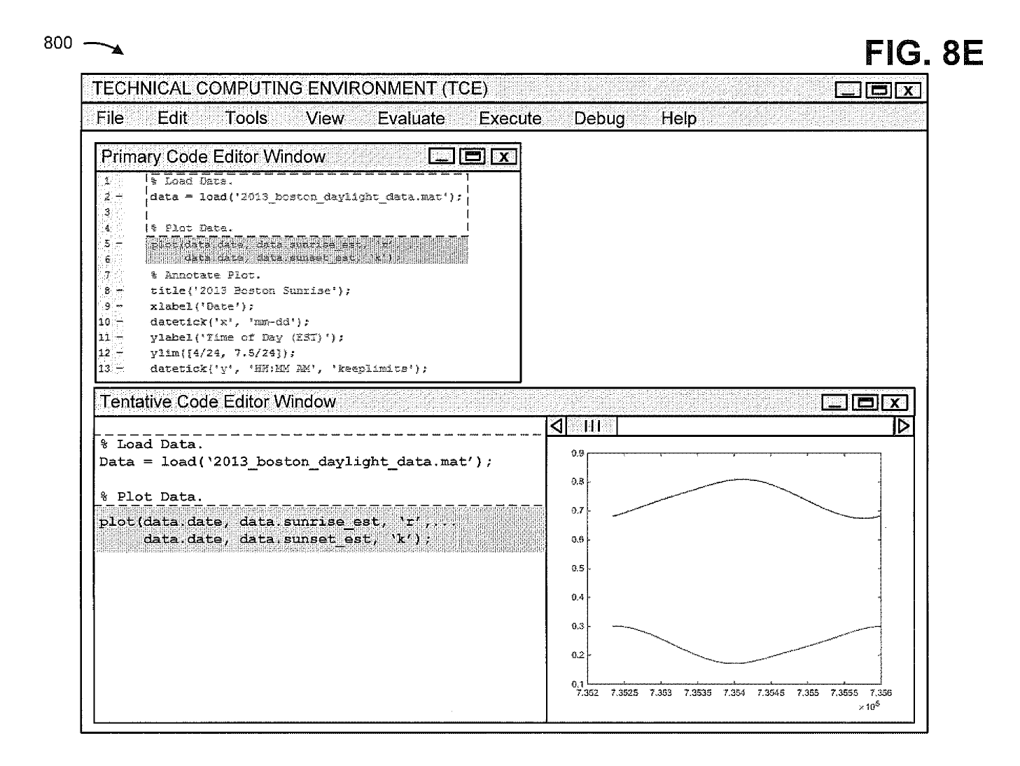

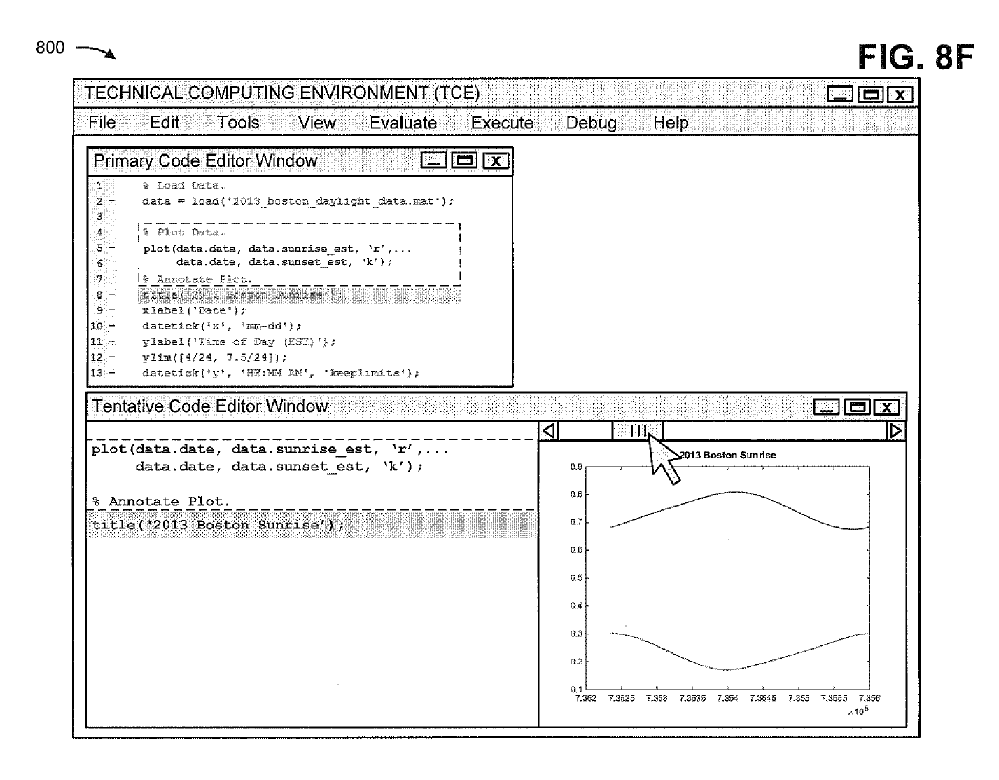

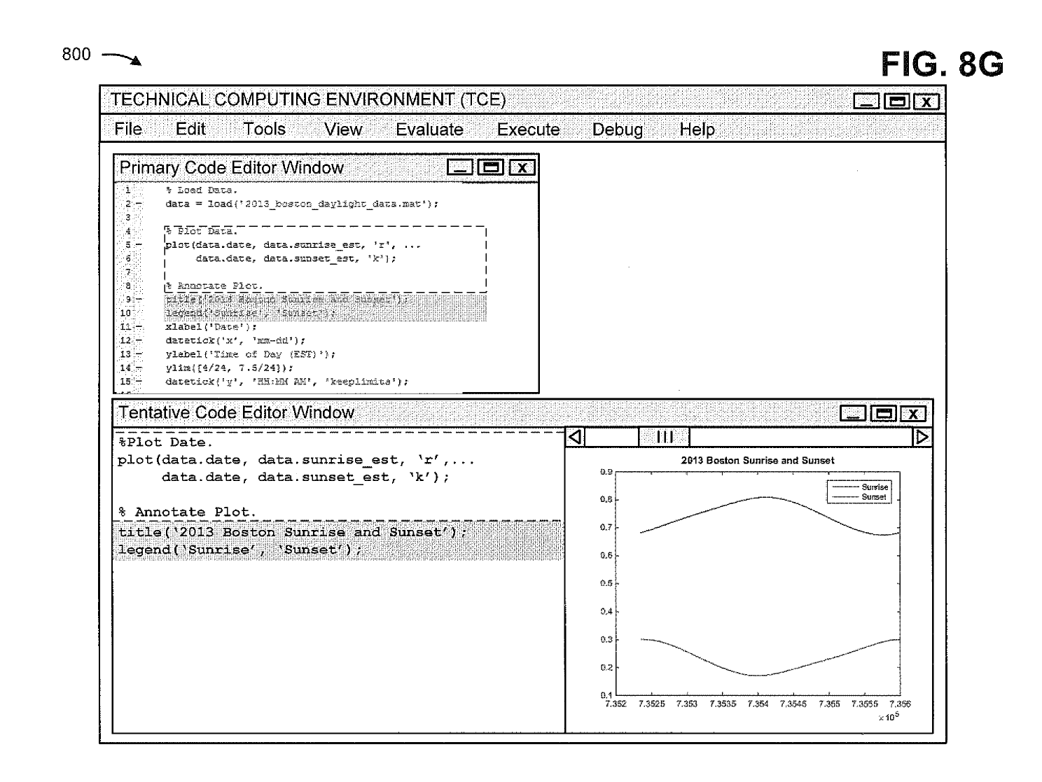

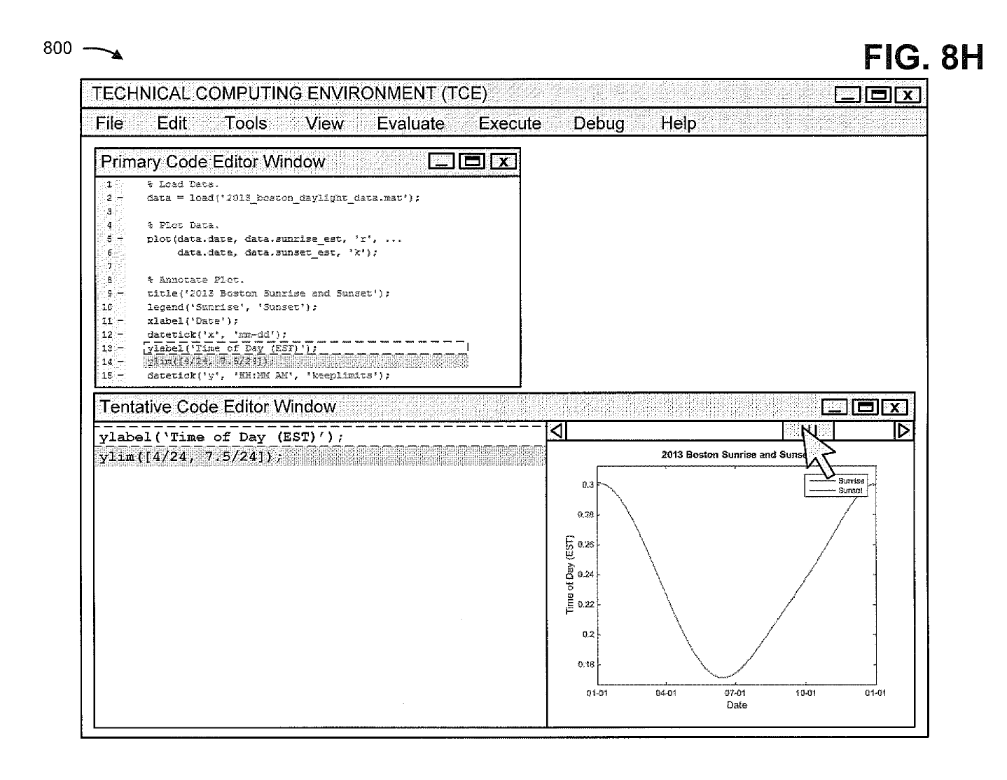

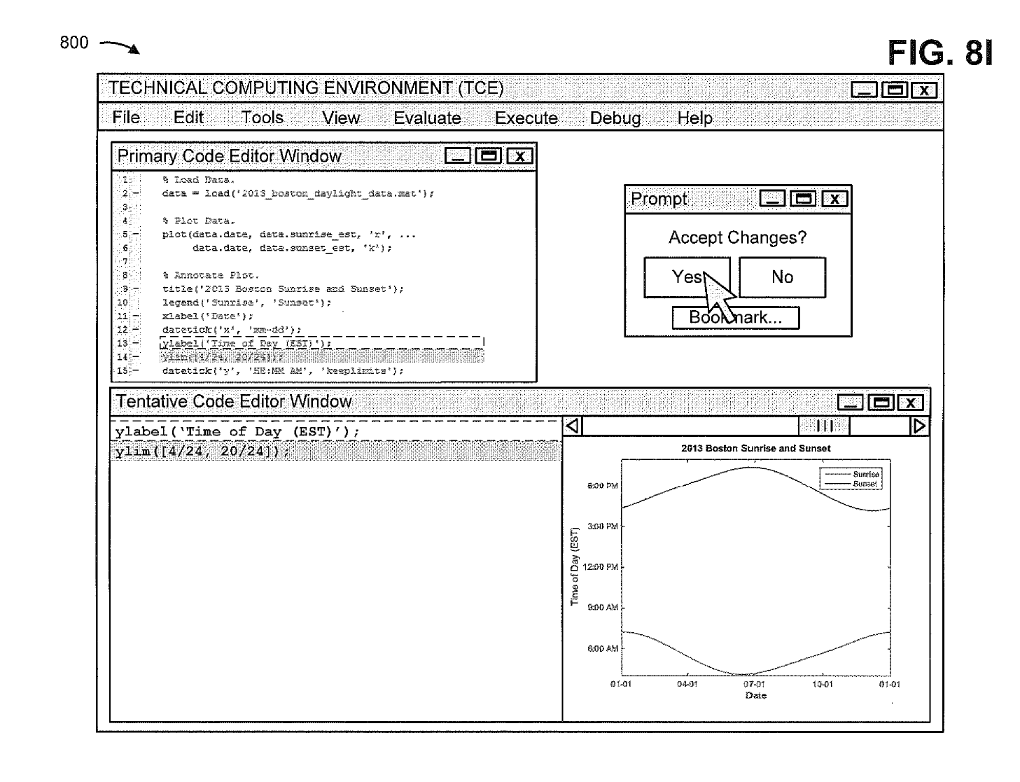

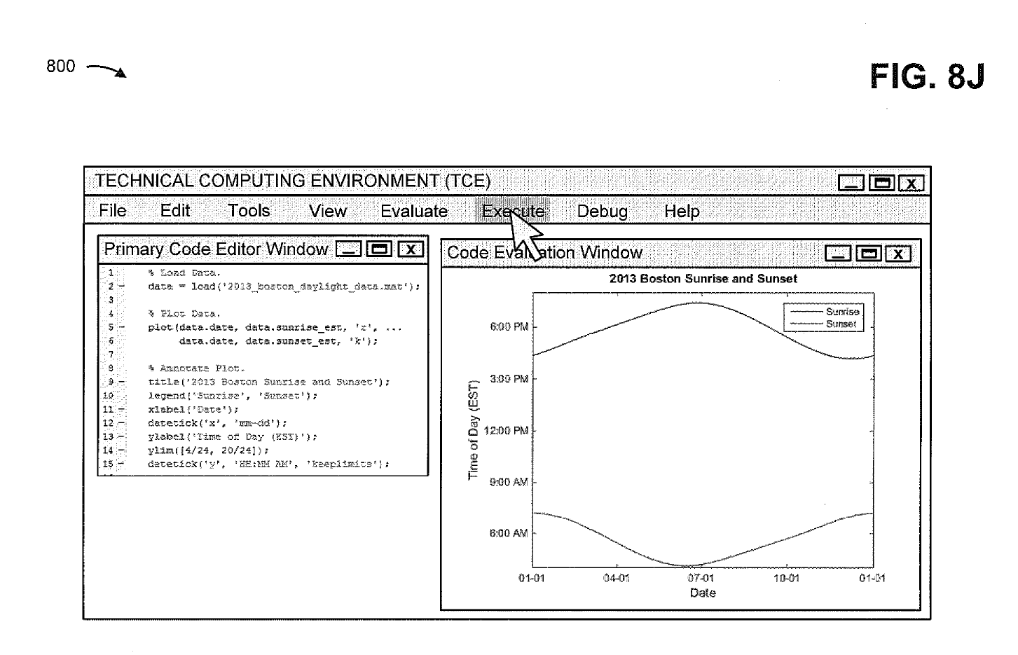

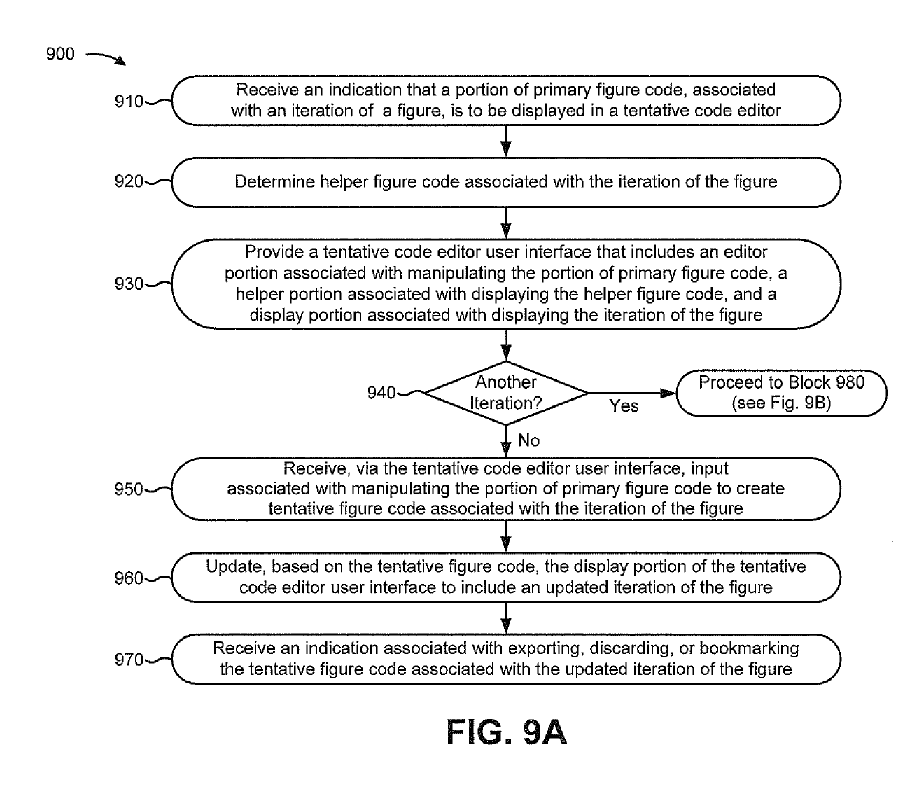

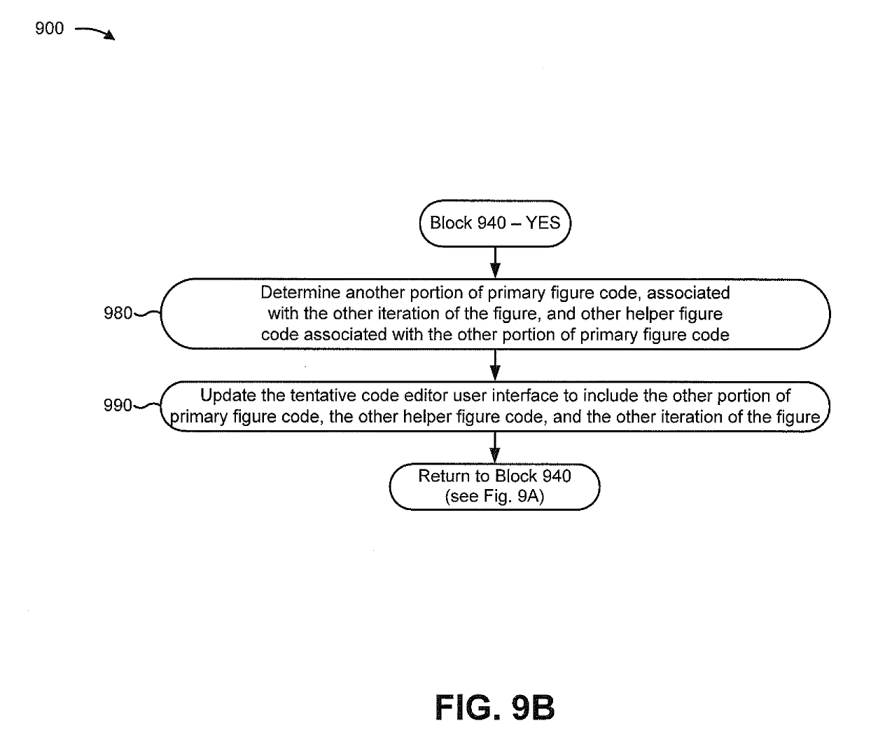

FIGS. 8A-8J are diagrams of an example implementation 800 relating to the example process shown in FIGS. 9A and 9B. For the purposes of example implementation 800, assume that a user has provided, via a primary editor of a technical computing environment (TCE), primary figure code that, when executed, results in a figure being displayed via the TCE. Further, assume that the user wishes to modify a portion of the primary figure code in a tentative editor to create tentative figure code, but that the user wishes to see an updated iteration of the figure, associated with the tentative figure code, before including the tentative figure code in the portion of primary figure code. Finally, assume that the TCE is capable of providing a tentative editor that allows the user to modify the portion of primary figure code to create tentative figure code and view an updated iteration of the figure without permanently modifying the primary figure code in the primary editor.

As shown in FIG. 8A, TCE may receive an indication that the user wishes to view a first portion of primary figure code (e.g., associated with a first iteration of a figure that depicts 2013 Boston sunrise data) in the tentative editor (e.g., when the user double clicks the figure displayed in the TCE). For the purposes of example implementation 800, assume that selecting the figure in this manner results in TCE providing a tentative editor user interface associated with a final iteration of the figure. In other words, TCE may determine that a first portion of primary figure code that is to be initially displayed in the tentative editor is the last line of primary figure code that corresponds to the figure (e.g., datetick(‘y’, ‘HH:MM AM’, ‘keeplimits’);).

As shown in FIG. 8B, TCE may determine first helper figure code (e.g., ylim([4/24, 7.5/24]);) associated with the first portion of primary figure code (e.g., when helper figure code is determined based on the line of primary figure code immediately preceding the primary figure code that corresponds to the iteration of the figure). As shown, TCE may determine a first iteration of the figure (e.g., the final iteration of the figure) associated with the first portion of primary figure code. As shown, TCE may display a tentative editor window including an editor portion that includes the first portion of primary figure code. As further shown, TCE may also display a helper portion of the tentative editor window that includes the first helper figure code associated with the first primary figure code. As shown, TCE may further display a display portion of the tentative editor window that includes the first iteration of the figure associated with the first portion of primary figure code. As further shown, TCE may also identify the corresponding first portion of primary figure code and the first helper figure code in the primary editor (e.g., by highlighting the code, by surrounding the code with a dashed line, etc.).

As shown in FIG. 8C, the user may select a second (e.g., previous) iteration of the figure by clicking and dragging within a scroll bar included in the display portion of the tentative editor user interface. As shown, the user may scroll to the second iteration of the figure (e.g., an iteration of the figure immediately preceding the first iteration of the figure). As shown, TCE may determine a second portion of primary figure code associated with the second iteration of the figure (e.g., ylim([4/24, 7.5/24]);), may determine, second helper figure code associated with the second portion of primary figure code (e.g., ylabel (‘Time of Day (EST)’);) and may update the tentative editor user interface to include the second portion of primary figure code, the second helper figure code, and the second iteration of the figure.

As shown in FIG. 8D, the user may select a third iteration of the figure by continuing to click and drag within the scroll bar included in the display portion of the tentative editor user interface. As shown, the user may scroll to the third iteration of the figure (e.g., an initial iteration of the figure corresponding to the primary figure code). As shown, TCE may determine a third portion of primary figure code associated with the third iteration of the figure (e.g., plot(data.date, data.sunrise_est);), may determine, third helper figure code associated with the third portion of primary figure code (e.g., data=load(‘2013_boston_daylight_data.mat’);); and may update the tentative editor user interface to include the third portion of primary figure code, the third helper figure code, and the third iteration of the figure.

As shown in FIG. 8E, TCE may receive, from the user and via the editor portion of the tentative editor window, input associated with modifying the third portion of primary figure code to create corresponding tentative figure code. As shown, the user may modify the third portion of primary figure code such that the figure will include sunset data (e.g., plot(data.date, data.sunrise_est, ‘r’, data.date, data.sunset_est, ‘k’);). As further shown, TCE may update, based on the tentative figure code, the display portion of the tentative editor user interface to include an updated third iteration of the figure. As shown, in some implementations, the primary editor window may be updated to reflect modifications within the primary figure code, but the modifications may not be permanent until indicated by the user, as discussed below.

As shown in FIG. 8F, the user may select a fourth iteration of the figure by clicking and dragging within the scroll bar included in the display portion of the tentative editor user interface. As shown, the user may scroll to the fourth iteration of the figure (e.g., an iteration of the figure immediately following the third iteration of the figure). As shown, TCE may determine a fourth portion of primary figure code associated with the fourth iteration of the figure (e.g., title(‘2013 Boston Sunrise’);) may determine fourth helper figure code associated with the fourth portion of primary figure code (e.g., plot(data.date, data.sunrise_est, ‘r’, data.date, data.sunset_est, ‘k’);) and may update the tentative editor user interface to include the fourth portion of primary figure code, the fourth helper figure code, and the fourth iteration of the figure.

As shown in FIG. 8G, TCE may receive, from the user and via the editor portion of the tentative editor window, input associated with modifying the fourth portion of primary figure code to create corresponding tentative figure code. As shown, the user may modify the fourth portion of primary figure code such that the figure will include an updated title (e.g., title(‘2013 Boston Sunrise and Sunset’);) and a legend (e.g., legend(‘Sunrise’, ‘Sunset’);). As further shown, TCE may update, based on the tentative figure code, the display portion of the tentative editor user interface to include an updated fourth iteration of the figure.

As shown in FIG. 8H, the user may re-select the second iteration of the figure by clicking and dragging within the scroll bar included in the display portion of the tentative editor user interface. As shown, the user may scroll to the second iteration of the figure. As shown, TCE may determine the second portion of primary figure code associated with the second iteration of the figure (e.g., ylim([4/24, 7.5/24]);) may determine the second helper figure code associated with the second primary figure code (e.g., ylabel(‘Time of Day (EST)’);), and may update the tentative editor user interface to include the second portion of primary figure code, the second helper figure code, and the second iteration of the figure.

As shown in FIG. 8I, TCE may receive, from the user and via the editor portion of the tentative editor window, input associated with modifying the second portion of primary figure code to create corresponding tentative figure code. As shown, the user may modify the second portion of primary figure code such that the y-axis of the figure will incorporate a larger range of values (e.g., ylim([4/24, 20/24]);). As further shown, TCE may update, based on the tentative figure code, the display portion of the tentative editor user interface to include an updated second iteration of the figure.

As further shown in FIG. 8I, assume that the user is satisfied with the update iteration of the figure displayed in the tentative editor window, and that the user provides an indication (e.g., by selecting a menu item, by right clicking the tentative code, etc.) that the user is finished modifying the primary figure code associated with the figure. As shown, TCE may prompt the user to indicate whether the tentative figure code (e.g., associated with the second iteration of the figure, the third iteration of the figure, and the fourth iteration of the figure) is to be accepted. As shown, the user may indicate (e.g., by clicking a Yes button) that the tentative code is to be accepted and exported in to the primary figure code in the primary editor.

As shown in FIG. 8J, TCE may finalize the replacement (e.g., within the primary editor) of the portions of primary figure code with the tentative figure code based on the indication that the tentative code is to be exported (e.g., TCE may overwrite the portions of primary figure code, in the primary editor, with the corresponding tentative figure code). As further shown, the user may indicate (e.g., by selecting an Execute menu item) that TCE is to execute the primary figure code, and TCE may execute the primary figure code and display the figure generated by executing the primary figure code.

As indicated above, FIGS. 8A-8J are provided merely as an example. Other examples are possible and may differ from what was described with regard to FIGS. 8A-8J.

FIGS. 9A and 9B are flow charts of an example process 900 for receiving tentative figure code associated, with an iteration of a figure, and displaying the iteration of the figure in the tentative editor. In some implementations, the process blocks of FIGS. 9A and 9B may be performed by user device 210. In some implementations, one or more process blocks of FIGS. 9A and 9B may be performed by another device or a group of devices separate from or including user device 210, such as server device 230.

As shown in FIG. 9A, process 900 may include receiving an indication that a portion of primary figure code, associated with an iteration of a figure, is to be displayed in a tentative editor (block 910). For example, user device 210 may receive (e.g., based on user input) an indication that a portion of primary figure code, associated with an iteration of a figure (e.g., an iteration of a graph, an iteration of a plot, an iteration of a chart, etc.), is to be displayed in a tentative editor. User device 210 may receive the indication based on a user interaction with a user interface of TCE 220, in some implementations. For example, a user may interact with an input mechanism (e.g., a menu item, a button, a double click on the primary figure code, etc.) to provide the indication to user device 210. As another example, a user may interact with a figure (e.g., by double clicking, by right clicking, etc.) to provide the indication that the portion of primary figure code, that corresponds to the figure, is to be displayed in the tentative editor, as shown in FIG. 8A.

Primary figure code may include program code (e.g., as defined above), associated with a primary editor of TCE 220, that, when executed, causes an iteration of a figure (e.g., a graph, a plot, a chart, a table, etc.) to be generated. In some implementations, the primary figure code may be provided to the primary editor by a user and/or may be associated with a model element of a model, as described above. An iteration of a figure may include a version of a figure that corresponds to the portion of primary figure code. For example, a first line of primary figure code may correspond to a first iteration of a figure. In this example, a second line of primary figure code (e.g., immediately following the first line of primary figure code) that causes the first iteration of the figure to be modified (e.g., a line of program code that causes a title to be added to the figure) may correspond to a second iteration of the figure. Similarly, a third line of primary figure code (e.g., immediately following the second line of primary figure code) may correspond to a third iteration of the figure.

In some implementations, a tentative editor may allow the user to manipulate (e.g., via a tentative editor user interface) the portion of primary figure code to create tentative figure code without modifying the portion of primary figure code, in a manner similar to that described above with regard to block 410.

As further shown in FIG. 9, process 900 may include determining helper figure code associated with the iteration of the figure (block 920). For example, user device 210 may determine helper figure code associated with the iteration of the figure. In some implementations, user device 210 may determine the helper figure code, associated with the iteration of the figure, when user device 210 receives the indication that the portion of primary figure code is to be displayed in the tentative editor.

Helper figure code, associated with a figure, may include program code that corresponds to a previous iteration of the figure. For example, a first line of primary figure code may correspond to a first iteration of a figure. In this example, if TCE 220 receives an indication that a second line of primary figure code (e.g., that corresponds to a second iteration of the figure) is to be displayed in the tentative editor, then TCE 220 may determine that the helper figure code is the first line of primary figure code (e.g., since the first line of primary figure code corresponds to the previous iteration of the figure).

In some implementations, user device 210 (e.g., TCE 220) may determine the helper figure code by analyzing the portion of primary figure code, as described above. Additionally, or alternatively, TCE 220 may determine the helper figure code by identifying primary figure code that corresponds to the previous iteration of the figure. Additionally, or alternatively, TCE 220 may determine the helper figure code by identifying the helper figure code as being primary figure code that immediately precedes (e.g., in the primary editor) the portion of primary figure code that is to be displayed in the tentative editor. Additionally, or alternatively, the helper figure code may include other program code associated with a primary editor (e.g., the helper figure code may include one or more other lines of program code as displayed in the primary editor).

As further shown in FIG. 9A, process 900 may include providing a tentative editor user interface that includes an editor portion associated with manipulating the portion of primary figure code, a helper portion associated with displaying the helper figure code, and a display portion associated with displaying the iteration of the figure (block 930). For example, user device 210 may provide, via TCE 220, a tentative editor user interface that includes an editor portion associated with displaying the portion of primary figure code, a helper portion associated with displaying the helper figure code, and an display portion associated with displaying the iteration of the figure.

In some implementations, user device 210 may concurrently provide the editor portion, the helper portion, and the display portion via the user interface (e.g., the portions may be displayed on the user interface at the same time), similar to the manner described above with respect to block 430, and as shown in FIG. 8B.

As further shown in FIG. 9A, process 900 may include determining whether information identifying another iteration of the figure has been received via the tentative editor user interface (block 940). For example, user device 210 may determine whether information identifying another iteration of the figure has been received via the tentative editor user interface. In some implementations, user device 210 (e.g., TCE 220) may determine whether the information identifying the other iteration of the figure has been received after user device 210 provides the tentative editor user interface.

In some implementations, user device 210 may determine whether the information identifying the other iteration of the figure has been received based on user input provided via the tentative editor user interface. For example, the display portion of the tentative editor user interface may include an input element, such as a scroll bar, that allows the user to provide (e.g., by scrolling) the information identifying the other iteration of the figure, as shown in FIGS. 8C, 8D, 8F, and 8H. In this example, the iteration of the figure (e.g., corresponding to the portion of primary figure code selected by the user) may be associated with a first position on the scroll bar, and user device 210 may receive the information identifying the other iteration of the figure based on the user identifying the other iteration of the figure by selecting a second position on the scroll bar (e.g., by scrolling left, scrolling right, scrolling up, scrolling down, etc.). In some implementations, the user may identify another iteration of the figure in another manner.

As further shown in FIG. 9A, if information identifying the other iteration of the figure has not been received via the tentative editor user interface (block 940—NO), then process 900 may include receiving, via the tentative editor user interface, input associated with manipulating the portion of primary figure code to create tentative figure code associated with the iteration of the figure (block 950). For example, user device 210 may receive, via the tentative editor user interface, input associated with modifying the portion of primary figure code to create tentative figure code, as shown in FIGS. 8E, 8G, and 8I. In some implementations, user device 210 may receive the input when user device 210 (e.g., TCE 220) provides the tentative editor user interface (e.g., after user device 210 provides the tentative editor user interface).

In some implementations, the user may provide the input via the editor portion of the tentative editor user interface. For example, the user may provide the input to the editor portion of the tentative editor user interface via a keyboard of user device 210, a touch screen of user device 210, a mouse associated with user device 210, or another input mechanism. In some implementations, the input may indicate a manner in which the portion of primary figure code is to be manipulated to create tentative figure code. For example, the input may indicate that additional figure code is to be added to the portion of primary figure code (e.g., the input may identify figure code associated with adding a title to the figure, the input may identify figure code associated with adding a legend to the figure). As another example, the input may indicate that the portion of primary figure code is to be modified in another manner (e.g., the input may identify figure code associated with modifying a y-axis range of the figure, etc.).

As further shown in FIG. 9A, process 900 may include updating, based on the tentative figure code, the display portion of the tentative editor user interface to include an updated iteration of the figure (block 960). For example, user device 210 may update, based on the tentative figure code, the display portion of the tentative editor user interface to include an updated iteration of the figure.

In some implementations, user device 210 may update the display portion based on a user interaction with a user interface of TCE 220. For example, the user may provide the input associated with manipulating the portion of primary figure code to create the tentative figure code, and the user may interact with an input mechanism (e.g., a menu item, a button, a tool bar item, a gesture, an interaction with a touch screen, etc.) to indicate that user device 210 is to update the display portion based on the input. Additionally, or alternatively, user device 210 may update the display portion based on receiving the input associated with manipulating the portion of primary figure code. For example, the user may provide the input associated with manipulating the portion of primary figure code to create the tentative figure code, and user device 210 may evaluate the tentative figure code (e.g., in real-time, after some time delay, etc.) based on the user providing the input, as shown in FIGS. 8E, 8G, and 8I.

In some implementations, user device 210 may update the iteration of the figure by modifying the iteration of the figure based on the tentative figure code. For example, the user may provide input indicating that an iteration of the figure (e.g., a plot that depicts a first x-axis range) is to be updated (e.g., such that the plot depicts a second x-axis range). In this example, user device 210 may update the display portion of the figure such that the plot depicts the second x-axis range (e.g., rather than the first x-axis range).

In some implementations, the user may continue to provide input, to user device 210, associated with manipulating the portion of primary figure code (e.g., to create additional tentative figure code), and user device 210 may update the display portion, accordingly (e.g., the user can continue to modify the iteration of the figure).

As further shown in FIG. 9A, process 900 may include receiving information associated with exporting, discarding, or bookmarking the tentative figure code associated with the updated iteration of the figure (block 970). For example, user device 210 may receive an indication associated exporting, discarding, or bookmarking the tentative figure code. In some implementations, user device 210 may receive the indication after user device 210 updates the display portion of the tentative editor user interface to include the updated iteration of the figure (e.g., after the user has viewed the updated iteration of the figure).

In some implementations, user device 210 may receive the indication based on a user interaction with a user interface of TCE 220. For example, a user may interact with an input mechanism (e.g., a menu item, a button, a tool bar item, a gesture, an interaction with a touch screen, etc.) to provide the indication to user device 210, as shown in FIG. 8I.

In some implementations, the indication may indicate that user device 210 is to export the tentative figure code in a manner similar to that described above with regard to block 780. In some implementations, the indication may indicate that user device 210 is to discard the tentative code in a manner similar to that described above with regard to block 780. In some implementations, the indication may indicate that user device 210 is to bookmark the tentative code in a manner similar to that described above with regard to block 780.

As shown in FIG. 9B, if information identifying another iteration of the figure has been received via the tentative editor user interface (block 940—YES), then process 900 may include determining another portion of primary figure code, associated with the other iteration of the figure, and other helper figure code associated with the other portion of primary figure code (block 980).

For example, user device 210 may determine that information identifying the other iteration of the figure has been received based on user input provided via the tentative editor user interface, as described above with regard to block 940. In this example, user device 210 may determine (e.g., based on the primary figure code included in the primary editor), another portion of primary figure code associated with the other iteration of the figure. User device 210 may also determine other helper figure code associated with the other portion of primary figure code (e.g., in the manner described with regard to block 920).

As further shown in FIG. 9B, process 900 may include updating the tentative editor user interface to include the other portion of primary figure code, the other helper figure code, and the other iteration of the figure (block 990). For example, user device 210 may update the tentative editor user interface such that the editor portion displays the other portion of primary figure code, the helper portion displays the other helper figure code, and the display portion displays the other iteration of the figure, as shown in FIGS. 8C, 8D, 8F, and 8H.

As further shown in FIG. 9B, the process 900 may return to block 940, and the user may select an additional iteration of the figure (e.g., the user may continue scrolling in the display portion of the tentative editor user interface, as described with regard to block 940). In this way, the user may view one or more iterations of the figure such that the user may can decide which iteration of the figure to modify (e.g., example process 900 may repeat blocks 940, 980, and 990 until the user decides which iteration of the figure to modify). After the user has chosen a particular iteration to modify, the user may provide input associated with modifying the portion of primary figure code that corresponds to the particular iteration of the figure, as described with regard to block 950.

Although FIGS. 9A and 9B shows example blocks of process 900, in some implementations, process 900 may include additional blocks, different blocks, fewer blocks, or differently arranged blocks than those depicted in FIGS. 9A and 9B. Additionally, or alternatively, two or more of the blocks of process 900 may be performed in parallel.

Implementations described herein may allow a user to provide tentative code to a tentative editor that may evaluate the tentative code and provide a result, associated with the tentative code, to the user. In this way, the user may experiment, test, modify, revise, etc. the tentative code before including the tentative code in primary code.

The foregoing disclosure provides illustration and description, but is not intended to be exhaustive or to limit the implementations to the precise form disclosed. Modifications and variations are possible in light of the above disclosure or may be acquired from practice of the implementations. For example, while the foregoing description discusses a tentative editor in the context of selecting an already-exiting primary code portion (e.g., associated with a primary editor that includes primary code) for editing in the tentative editor, an alternative implementation may allow a user to use the tentative code editor without selecting a primary code portion (e.g., such that the tentative code editor does not include any program code when initially provided to the user). In this alternative implementation, the user may provide tentative code to the tentative editor, and the tentative code may be exported from the tentative editor to a primary editor (e.g., a primary editor that does not include any program code when initially provided to the user).

Another alternative implementation may allow the user to provide code used to perform testing (e.g., unit testing, etc.), associated with the primary code, by selecting a primary code portion as a reference and providing test code associated with the reference. For example, assume that the primary editor includes a line of primary code (e.g., x=4+2). In this example, the user may indicate (e.g., by selecting the line of primary code, by selecting a menu item, by selecting a button, etc.) that the line of primary code is to be a reference associated with test code provided via the tentative code editor user interface. User device 210 may provide the tentative editor user interface (e.g., without including the line of primary code), and the user may provide test code (e.g., assertEqual(x,6)) associated with testing whether the line of primary code, when executed, provides a result of x=6. In this example, user device 210 may store the test code and information indicating that the line of primary code is the reference associated with the test code. The test code may then be executed each time the line of primary code is executed, and a result (e.g., a pass, a fail, a warning, an error, etc.), associated with the executing the test code, may be provided to the user each time the line of primary code is executed.

Another alternative implementation may allow the tentative editor to be used in a command window environment. For example, the user may select one or more commands from a command history (e.g., commands previously entered by the user), associated with the command window, and the one or more commands may be displayed in the tentative editor user interface (e.g., within the editor portion or within the helper portion). The user may then provide tentative code via the tentative editor, and iterate on the tentative code based on the one or more commands. The one or more commands may then be bookmarked (e.g., in the command history), discarded, or exported (e.g., into a primary editor).

As used herein, component is intended to be broadly construed as hardware, firmware, or a combination of hardware and software.

As used herein, program code is to be broadly interpreted to include text-based code that may not require further processing to execute (e.g., C++ code, Hardware Description Language (HDL) code, very-high-speed integrated circuits (VHSIC) HDL(VHDL) code, Verilog, Java, and/or other types of hardware or software based code that may be compiled and/or synthesized); binary code that may be executed (e.g., executable files that may directly be executed by an operating system, bitstream files that can be used to configure a field programmable gate array (FPGA), Java byte code, object files combined together with linker directives, source code, makefiles, etc.); text files that may be executed in conjunction with other executables (e.g., Python text files, a collection of dynamic-link library (DLL) files with text-based combining, configuration information that connects pre-compiled modules, an extensible markup language (XML) file describing module linkage, etc.); etc. In one example, program code may include different combinations of the above-identified classes (e.g., text-based code, binary code, text files, etc.). Additionally, or alternatively, program code may include code generated using a dynamically-typed programming language (e.g., the M language, a MATLAB® language, a MATLAB-compatible language, a MATLAB-like language, etc.) that can be used to express problems and/or solutions in mathematical notations. Additionally, or alternatively, program code may be of any type, such as a function, a script, an object, etc., and a portion of program code may include one or more characters, lines, etc. of the program code.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms.

Certain user interfaces have been described herein. In some implementations, the user interfaces may be customizable by a device or a user. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive an indication that a portion of primary program code is to be displayed in a tentative code editor,
the portion of primary program code being program code displayed in a primary code editor;
provide a tentative code editor user interface that includes an editor portion and an evaluation portion,
the editor portion being associated with manipulating the portion of primary program code, and
the evaluation portion being associated with displaying a result associated with the portion of primary program code;
receive, via the tentative code editor user interface, input associated with manipulating the portion of primary program code to create tentative program code;
evaluate the tentative program code;
provide, via the evaluation portion, a result associated with evaluating the tentative program code; and
receive an indication associated with exporting, discarding, or bookmarking the tentative program code.

2. The device of claim 1, where the one or more processors are further to:
determine helper program code associated with the portion of primary program code,
the helper program code being program code associated with a dependency of the portion of primary program code; and
where the one or more processors, when evaluating the tentative program code, are further to:
evaluate the tentative program code based on the helper program code.

3. The device of claim 1, where the one or more processors are further to:
receive an indication associated with evaluating the tentative program code in-real time; and
where the one or more processors, when evaluating the tentative program code, are further to:
evaluate the tentative program code in real-time based on receiving the indication associated with evaluating the tentative program code in-real time.

4. The device of claim 1, where the one or more processors, when receiving the indication associated with exporting, discarding, or bookmarking the tentative program code, are further to:
receive an indication associated with exporting the tentative program code; and
export the tentative program code from the tentative code editor to the primary code editor associated with the primary program code,
exporting the tentative program code including replacing the portion of primary program code, in the primary code editor, with the tentative program code.

5. The device of claim 1, where the one or more processors when receiving the indication associated with exporting, discarding, or bookmarking the tentative program code, are further to:
receive an indication associated with discarding the tentative program code; and
discard the tentative program code such that the portion of primary program code, in the primary code editor, is unchanged.

6. The device of claim 1, where the one or more processors, when receiving the indication associated with exporting, discarding, or bookmarking the tentative program code, are further to:
receive an indication associated with bookmarking the tentative program code; and
bookmark the tentative program code within the primary code editor associated with the primary program code,
bookmarking the tentative program code in the primary code editor including associating the tentative program code with a line of program code, included in the primary program code, without including the tentative program code in the primary program code.

7. The device of claim 1, where the one or more processors, when providing the tentative code editor user interface, are further to:
provide the editor portion within a window included in the tentative code editor user interface; and
provide the evaluation portion within a plurality of other windows included in the tentative code editor user interface.

8. A method, comprising:
identifying that a portion of primary program code is to be displayed via a tentative code editor,
the portion of primary program code being program code included in a primary code editor, and
the identifying being performed by a device;
determining helper program code associated with the portion of primary program code,
the helper program code being program code associated with evaluating the portion of primary program code, and
the determining being performed by the device;
causing a tentative code editor user interface to be displayed,
the tentative code editor user interface including an editor portion associated with modifying the portion of primary program code,
the tentative code editor user interface including a helper portion associated with displaying the helper program code,
the tentative code editor user interface including an evaluation portion associated with displaying a result associated with the portion of primary program code, and
the causing being performed by the device;
receiving input associated with modifying the portion of primary program code to create tentative program code,
the receiving the input being performed by the device;
evaluating the tentative program code to determine a result,
the evaluating being based on the helper program code, and
the evaluating being performed by the device;
providing the result via the evaluation portion of the tentative code editor user interface,
the providing being performed by the device; and
receiving an indication to export, discard, or bookmark the tentative program code,
the receiving the indication being performed by the device.

9. The method of claim 8, further comprising:
receiving an evaluation indication to evaluate the tentative program code,
the evaluation indication being based on user input; and
where evaluating the tentative program code further comprises:
evaluating the tentative program code based on receiving the evaluation indication.

10. The method of claim 8, where the helper portion of the tentative code editor user interface includes at least one of:
a first portion that is to display required helper program code,
the required helper program code being program code required to evaluate the portion of primary program code; or
a second portion that is to display available helper program code,
the available helper program code being program code that is not required to evaluate the portion of primary program code.

11. The method of claim 8, where receiving the indication to export, discard, or bookmark the tentative program code further comprises:
receiving an indication to export the tentative program code; and
exporting the tentative program code from the tentative code editor to the primary code editor associated with the primary program code,
exporting the tentative program code including replacing the portion of primary program code, in the primary code editor, with the tentative program code.

12. The method of claim 8, where receiving the indication to export, discard, or bookmark the tentative program code further comprises:
receiving an indication to bookmark the tentative program code; and
bookmark the tentative program code within the primary code editor associated with the primary program code,
bookmarking the tentative program code in the primary code editor including associating the tentative program code with the primary program code, based on a threshold condition, associated with the primary program code, without including the tentative program code in the primary program code,
the threshold condition, when satisfied during execution of the primary program code, causing the tentative program code to be executed.

13. The method of claim 8, where causing the tentative code editor user interface to be displayed further comprises:
causing a first window to be displayed,
the first window including the editor portion of the tentative code editor user interface; and
causing at least one other window to be displayed,
the at least one other window including the evaluation portion of the tentative code editor user interface.

14. A device, comprising:
one or more processors to:
receive an indication that a portion of primary figure code is to be displayed in a tentative code editor,
the portion of primary figure code being program code, displayed in a primary code editor, that corresponds to an iteration of a figure;
determine helper figure code associated with the portion of primary figure code,
the helper figure code being program code associated with a previous iteration of the figure;
provide a tentative code editor user interface that includes an editor portion, a helper portion, and a display portion,
the editor portion being associated with manipulating the portion of primary figure code,
the helper portion being associated with displaying the helper figure code, and
the display portion being associated with displaying the iteration of the figure;
receive information associated with manipulating the portion of primary figure code to create tentative figure code;
update the iteration of the figure, displayed in the display portion, based on the tentative figure code; and
receive an indication associated with exporting, discarding, or bookmarking the tentative figure code.

15. The device of claim 14, where the one or more processors are further to:
receive, via the tentative code editor user interface, information associated with another iteration of the figure;
determine another portion of primary figure code associated with the other iteration of the figure;
determine other helper code associated with the other iteration of the figure; and
update the tentative code editor user interface to include the other portion of primary figure code, the other helper figure code, and the other iteration of the figure.

16. The device of claim 14, where the one or more processors, when receiving the indication associated with exporting, discarding, or bookmarking the tentative figure code, are further to:
receive an indication associated with exporting the tentative figure code; and
export the tentative figure code from the tentative code editor to the primary code editor associated with the primary figure code,
exporting the tentative figure code including replacing the portion of primary figure code, in the primary code editor, with the tentative figure code.

17. The device of claim 14, where the one or more processors, when receiving the indication associated with exporting, discarding, or bookmarking the tentative figure code, are further to:
receive an indication associated with discarding the tentative figure code; and
discard the tentative figure code such that the portion of primary figure code, in the primary code editor, is unchanged.

18. The device of claim 14, where the one or more processors, when receiving the indication associated with exporting, discarding, or bookmarking the tentative figure code, are further to:
receive an indication associated with bookmarking the tentative figure code; and
bookmark the tentative figure code within the primary code editor associated with the primary figure code,
bookmarking the tentative figure code within the primary code editor including associating the tentative figure code with the primary figure code without including the tentative figure code in the primary figure code.

19. The device of claim 14, where the portion of primary figure code is a first portion of primary figure code, the helper figure code is first helper figure code, and the iteration of the figure is a first iteration of the figure,
the first iteration of the figure being a result associated with evaluating the first portion of primary figure code based on the first helper figure code; and
where the one or more processors are further to:
receive an indication that a second portion of primary figure code, associated with a second iteration of the figure, is to be displayed in the tentative code editor,
the indication being based on user input,
the second portion of primary figure code being different than the first portion of primary figure code, and
the second iteration of the figure being different than the first iteration of the figure;
determine second helper figure code associated with the second portion of primary figure code,
the second helper figure code being different than the first helper figure code;
update the tentative code editor user interface to include the second portion of primary figure code, the second helper figure code, and the second iteration of the figure;
receive information associated with manipulating the second portion of primary figure code to create tentative figure code;
update the second iteration of the figure based on the tentative figure code; and
receive an indication associated with exporting, discarding, or bookmarking the tentative figure code associated with the second iteration of the figure.

20. The device of claim 14, where the one or more processors, when providing the tentative code editor user interface, are further to:
provide a first window,
the first window comprising the editor portion of the tentative code editor user interface; and
provide a second window,
the second window comprising the display portion of the tentative code editor user interface.

21. A device, comprising:
one or more processors to:
receive a first indication to provide a tentative code editor user interface;
provide, based on the first indication, the tentative code editor user interface,
the tentative code editor user interface including an editor portion and an evaluation portion;
receive, via the editor portion, tentative program code;
evaluate the tentative program code;
provide, via the evaluation portion, a result associated with evaluating the tentative program code;
receive a second indication associated with exporting the tentative program code to a primary code editor or discarding the tentative program code; and
cause, based on the second indication, the tentative program code to be exported to the primary code editor or to be discarded.

22. The device of claim 21, where the primary code editor does not include program code at the time that the one or more processors receive the tentative program code.

23. The device of claim 21, where causing the tentative program code to be exported from the tentative code editor to the primary code editor includes:
causing the tentative program code to be displayed in a primary code editor user interface associated with the primary code editor.

24. A device, comprising:
one or more processors to:
receive a first indication to provide a tentative code editor interface,
the first indication being associated with a portion of primary program code,
the portion of primary program code being included in a primary code editor;
provide, based on the first indication, the tentative code editor interface,
the tentative code editor interface including an editor portion;
receive, via the editor portion, tentative program code,
the tentative program code being program code associated with testing a result associated with executing the portion of primary program code;
receive a second indication associated with storing the tentative program code; and
cause, based on the second indication, the tentative program code to be stored,
the tentative program code being stored such that the tentative program code is executed each time the portion of primary program code is executed.
